(19) United States
(12) Patent Application Publication
(10) Pub. No.: US 2013/0004935 A1
(43) Pub. Date: Jan. 3, 2013

(54) ONLINE SOCIAL LEARNING SYSTEMS, METHODS, AND COMPUTER PROGRAM PRODUCTS

(75) Inventors: Christopher Smith, Andover, MA (US); Jennifer Smith, Andover, MA (US)

(73) Assignee: AMERICAN GRAPHICS INSTITUTE, LLC, Woburn, MA (US)

(21) Appl. No.: 13/532,879

(22) Filed: Jun. 26, 2012

Related U.S. Application Data
(60) Provisional application No. 61/501,914, filed on Jun. 28, 2011.

(51) Int. Cl. G09B 25/00

(52) U.S. Cl. 434/365

(57) ABSTRACT

Provided is a system, method and computer program product for providing interactive online learning.

This application claims priority to U.S. Provisional Patent Application Ser. No. 61/501,914, filed Jun. 28, 2011, the complete disclosure of which is incorporated herein by reference.

### FIELD OF THE INVENTION

The present invention generally relates to online learning systems, and more particularly, to a system, method and computer program product for providing interactive online learning.

### BACKGROUND OF THE INVENTION

When teaching classes, instructors often are faced with many pieces of content, ranging from chapters of various books and video tutorials to their own content, and they lack an easy way to organize the various content types, present it in an appropriate sequence, and share it with students. Instructors also lack a way to provide a single location for users to access everything they may need for an assignment or project.

Video training exists at several sites where users can subscribe on a monthly or annual basis to watch a range of videos. However, all of these are simply a large collection of videos without any pedagogy, and instructors are unable organize the content, instructors cannot share the content in a specific sequence, and none of the sites contain both books and videos. Sites that allow viewing of books do not allow them to be broken up by chapter.

Conventional book sites that do offer subscriptions to books require dedicated readers or applications, and they do not work on any web connected device or within the web browser.

### SUMMARY OF THE INVENTION

An objective of the present invention it so provide a system that solves the problem of disconnected resources for educators and instructors by allowing them to organize and place in one location all content a student needs for an assignment including book chapters from a digital book, video tutorials for a student to watch, notes and materials prepared by the instructor, and lesson files or additional resources uploaded by the instructor.

Another objective is to allow the content to be organized in a logical fashion by the instructor so that lessons are completed in the order desired, and content is presented to the student so it is read or viewed in the intended sequence. The materials organized by the instructor can be sent out to students who participate in the system.

Another objective is to provide a way for authors to establish a closed network with educators to share additional resources. Instructors can share lesson plans with each other, sharing the sequence in which content is organized and presented to students.

Another objective is to provide Individual learners, those learning independently outside a classroom, use of the social learning site to seek out experts such as instructors or other professionals who can provide mentoring and guidance, and propose a learning path for gaining new skills.

A further objective of the invention is to provide instructors an efficient and fast method for preparing tutorials or lessons.

Another objective is to allow instructors to merge together chapters from various books and lessons from various video tutorials to create a set of course content specific to the needs of a class or instructor.

A further objective of the invention is to provide online content to a user and when the user reads a certain number of pages to reach a milestone a reward is provided to an online social network.

The above objectives and other objectives are provided by a method of using an online social learning system to prepare a lesson or tutorial comprising:
connecting to a cloud based social learning server over a network by a user device having a display;
displaying on the user device education material comprising videos, electronic books, or text;
selecting desired educational content from the education material;
optionally uploading user supplied desired content to the social learning server; and
sequencing the selected content to prepare at least one lesson or tutorial, wherein a student user can view the content in the sequence.

The objectives are further provided by a method of using an online social learning system comprising:
connecting to a cloud based social learning server over a network by a user device having a display;
displaying on the user device educational content comprising video content, electronic books or text;
selecting desired educational content;
tacking pages of educational content viewed by the user; and
providing a reward when a milestone is reached by the user, the milestone comprising a number of pages to be viewed by the user.

The objectives are further provided by an online social learning system comprising:
a cloud based social learning server configured to communicate with a plurality of user devices over a network, the cloud based social learning server comprising a non-transitory memory storing information, the social learning server constructed to monitor pages of educational content opened by a user device and when the pages were opened by the user device;
a membership database located in the non-transitory memory of the social learning server or on a cloud based membership server connected to the network, the membership database constructed to store personal user data including a password and username, and allow grouping of users;
an ePub library located in the non-transitory memory of the social learning server or on a cloud based membership server connected to the network, the ePub library comprising educational books;
a video library located in the non-transitory memory of the social learning server or on a cloud based membership server connected to the network, the video library comprising educational videos;
an instructor's library located in the non-transitory memory of the social learning server or on a cloud based membership server connected to the network, the instructor's library comprising a plurality of tutorials that each comprises content sequenced by an instructor user and wherein at least some of the tutorials include video content, electronic books, or text that the instructor can use to prepare a lesson, and optionally content uploaded by the instructor user;
a first interface for posting milestone and other information of a user to user's social network page when a milestone has been reached, the milestone comprising a number of pages opened on the user device;
a message module configured to facilitate communications between users;
a second message module configured to allow users to receive, store and transmit comments on specific locations within videos and tutorials to thereby share comments with other users; and
a video streaming module configured to stream live or pre-recorded video to a user.

The objectives are further provided by a computer program product, comprising a computer usable medium having a computer readable program code embodied therein. The computer readable program code adapted to be executed to implement the methods for providing online learning described herein.

### BRIEF DESCRIPTION OF THE DRAWINGS

FIG. 1A illustrates an online social learning system of an embodiment of the invention.

FIGS. 1B-11 illustrate flow charts of an embodiment of the invention .

FIG. 12 illustrates a social online learning site as experienced by the user.

FIG. 13 illustrates a member signing into the social online learning site.

FIGS. 14 and 15 illustrates a member joining the social online learning site.

FIG. 16 illustrates a user viewing the library of videos.

FIG. 17 illustrates a user accessing individual videos.

FIGS. 18-19 illustrates a user accessing eBooks.

FIG. 20 illustrates a screen a user will see if they are not a member and attempt to view content on the system.

FIGS. 21-22 illustrates a user posting comments regarding content on the system.

FIG. 23 Illustrates a user adding a bookmark of a location within an electronic book to share with other users.

FIGS. 24-25 illustrates a user accessing a group on the system.

FIG. 26 illustrates a user sharing messages with members of a group.

FIG. 27 illustrates groups to which a user belongs.

FIG. 28 illustrates a user creating a new topic for discussion in a group.

FIG. 29 illustrates how a user can see a group to which a member belongs.

FIG. 30 illustrates how users of the site can view others members on the site.

FIG. 31 illustrates an award or progress notation being provided to a user who has completed a set milestone.

FIG. 32 illustrates registered users creating a list of tutorials and books to consume later by placing them into a queue.

FIG. 33 illustrates the user's content queue, or list of educational content, to be consumed by the user at a later time.

FIG. 34 Illustrates the queue of content, including videos, eBooks, and tutorials that a user has saved to be viewed or read at a later time.

FIG. 35 illustrates a user adjusting the sequence of the content in the user's queue .

FIG. 36 illustrates removing items from their queue of tutorials, videos, and eBooks.

FIG. 37 illustrates instructors combining pieces of content into tutorials.

FIG. 38 illustrates a how a user will experience a tutorial created by instructor users.

FIG. 39 illustrates an instructor adding content into a tutorial.

FIGS. 40-45 illustrates that the educational content from the social online learning site can be accessed on multiple platforms and devices including mobile devices and the layout adapts to the available screen size.

FIG. 46-50 illustrates a user sharing messages to external social networking sites.

FIG. 51 illustrates lesson files which accompany books and videos.

FIG. 52 illustrates that instructors using the site have access to extra materials to help them teach.

FIG. 53 illustrates how instructors can create new tutorials for students they are teaching.

FIGS. 54-56 illustrates that organization-level accounts in the invention provide controls to school administrators or business administrators.

FIGS. 57-58 illustrate how users of the system can search for content in training videos and videos.

### DETAILED DESCRIPTION OF THE INVENTIONS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention can be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

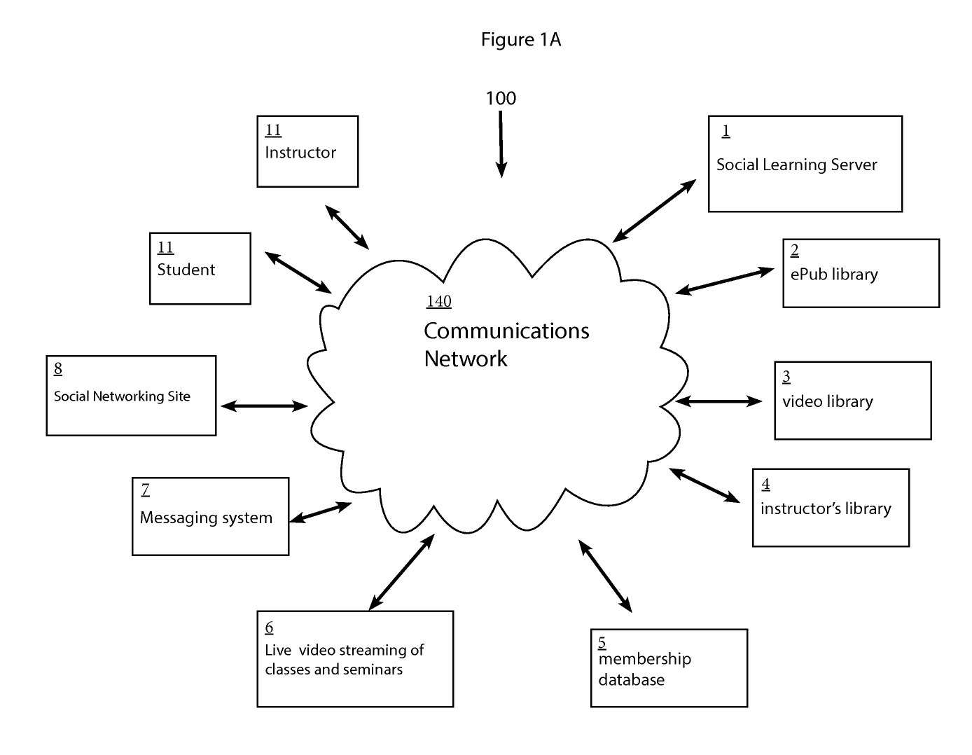

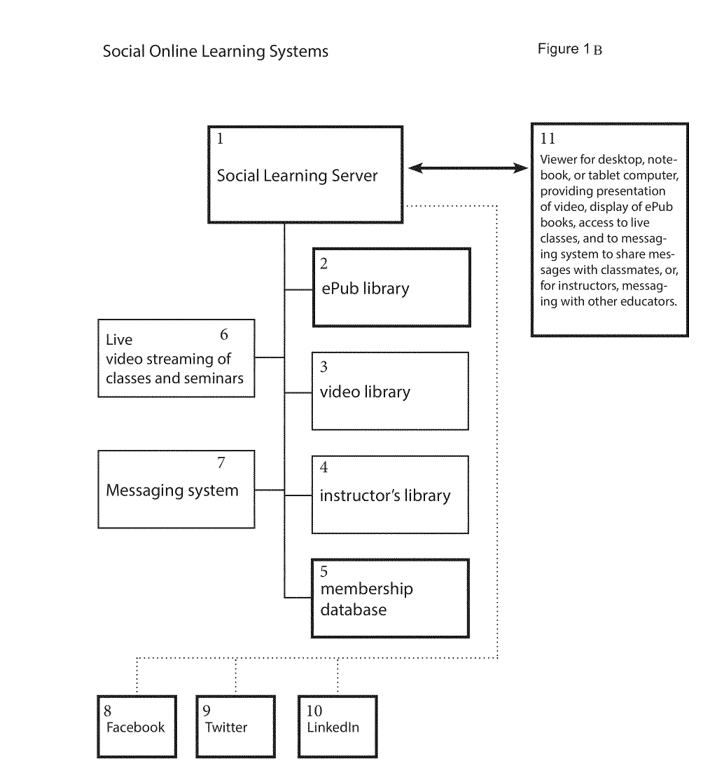

The invention comprises, in one embodiment as shown in FIG. 1A, a social online learning system (100). The system (100) comprises a cloud based social network server (1) connected to a network (140). User devices (11) are connected to the network (140). The user device (11) has a display for displaying information and can be used by instructors users (11) (also referred to as teachers), student users (11), or other users (11). The server (1) is connected via the network (140) to digital libraries containing eBooks or digital books (2), videos (3), instructor supplied content (4), and a membership database (5). If desired, any of the separate digital libraries can be contained in the memory of the server (1).

Various networks (140) may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Embodiments of the present invention provide a platform for students, educators, and professionals to access educational material comprising electronic books, videos, or text and collaborate on-line. Some embodiments can comprise a membership-based learning platform that allows free access to some educational content while charging monthly and/or annual membership fees to access all or additional services and content. Users that are members can log-in to the site, using a unique User ID and password they create on their first visit.

Individual or student users can use the network to access specific professional development content and professional groups can leverage the social learning platform for learning and sharing of information. Examples of student users include students of any school, college or university, such as secondary schools, community colleges, and universities. The student users can be located at a plurality of locations remote from the instructor and server (1). Live lessons (classes) or tutorials are available for streaming and can be recorded or stored and added to the video library. The system's video library system allows for lessons or tutorials to be recorded for playback at a later date as desired by the user.

The social learning server includes program code stored in a non-transitory or permanent computer readable medium that is executable to control the operation of the functions described herein such as to serve content, such as web pages, video, and electronic books, to users, such as students and instructors, to receive content from the user. The content can be stored in the non-transitory memory of one or more of the databases. Preferably the social learning server is cloud based, i.e. connected to the Internet. The program code for the ePub library, video library, instructor's library, membership database, messaging system, and live video streaming classes and seminars can be stored in a non-transitory computer readable medium on individual servers or on the social learning server.

Groups, which can be comprise a plurality of users, are for sharing information with others with whom the user can have a common interest. This might be because the user participates in one of the following:
a. Classes where a user wants to share information between student users or an instructor user wants to share information with student users.
b. Professional associations and professional groups where professional development opportunities and best practices might be shared.
c. Educators can participate in a group with subject matter experts and authors.

Users can request to be added to a group and the identity of the members of each group can be stored in memory.

Instructor users can be provided with additional resources, including the ability to monitor their own student users' progress towards completion of assignments (e.g., portions of lessons or classes) as well as access to authors and fellow educators for sharing information and best practices for teaching. Thus, in response to a request from an instructor user, the server can access the membership database and output a report to a client device of the instructor user that details the student users who have completed the assignment, started but not completed the assignment, what percentage of the assignment is completed, and/or the student users who did not start the assignment. In addition, information of when each student user started, completed, last worked on the assignment can be provided, which can be logged by the server as the student progresses through the assignment. In a preferred embodiment, the system monitors the pages viewed and when by the user to determine when the assignment was started and completed, as well as whether the assignment was completed.

The online social learning system can be accessed via any user device (11) that is capable of containing a web browser or similar program, allowing in some embodiments for a secure SSL connection, and able to display HTML and CSS. This includes user devises (11) such as iPads, Mac OS computers, Windows computers, e-readers, and mobile user devices such as the iPhone, Android, and Windows Phone. Mobile user devices (11) support the ability to play video and read ePubs. Users can start to read on a first user device (11) and then continue reading the content on another user device (11). Mobile user devices (11) preferably support reading as well as viewing videos. Preferred user devices (11) can connect to the server (1) to enable sharing of information and messaging. The user devices (11) can connect to the server via the internet and/or wirelessly, such as through a mobile telephone network, and/or any other suitable medium. User devices (11) are able to communicate to the server the progress of reading or viewing content so that the content can be started on one user device (11) and later continued on a separate user device (11). The information as to where a student user is in an assignment, such as a lesson, class or content, can automatically be logged by the server for each student user as each new content element is requested.

The online social learning system provides a unique learning experience that allows users, such as readers, students, professionals, and educators, to interact with other users.

The servers described herein can include one or more computer systems that each include a processor, memory, user input and user output mechanisms, a network interface, and executable program code (software) comprising computer executable instructions stored in non-transitory tangible memory that executes to control the operation of the server. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. Other embodiments can include different functional components. In addition, the present invention is not limited to a particular environment or server configuration.

The social online learning system comprises electronic libraries of educational content stored in various electronic formats in non-volatile memory that a registered user can access using a computer system for education, training, or professional development purposes. Users can browse content and add it to a learning queue to identify content they would like to view, and the queue can be saved for viewing at a later date. The content can include videos, electronic books, as well as notes and tutorials uploaded by instructors using the learning system. Teachers or educators can prepare tutorials for users to view on the user device. The tutorial can be formed in the same manner as a lesson. The tutorial is intended to be viewed by non-students and the lesson is intended to be viewed by students.

In one embodiment, instructors that are registered users can create a sequence of content for their students to follow in learning particular topics or subjects, referred to as a lesson. In the sequence of content, instructors can include books, book chapters, videos, and content they supply and upload into the system as part of the overall sequence of content. The books, book chapters, and videos can be from different books or authors, and the instructor can arrange the sequence in which they can be read or viewed by students.

Video libraries can be searched, and videos with relevant content to the search query will be listed, with the user being able to see how the video relates to the content being queried by seeing the portions of a transcript of the video that relate to the search query and markers in the video timeline indicating where the search terms are referenced in the video. If multiple videos from the video library contain the search terms, they will be displayed.

Administrator users and instructor users of the system can define goals and objectives, and student users can receive badges, progress indicators, or other markers to indicate their achievement or progress towards an educational goal or achievement. A user's achievements can be shared with other users of the system or with social networks to which the user belongs.

The ePub library comprises a plurality of electronic books stored in memory and can be accessed on-line and can be viewed on-line or stored locally on a personal computer, tablet computer, or mobile smartphone for reading and viewing off-line. The video library can comprise educational content stored in a non-transitory memory.

An instructor's library which can store information of “classes” which can comprise lessons including sequenced orders of content, for example video, electronic books, and html pages, that student users progress through to complete a classes. Instructor users can create lessons, for example custom courses, by assembling texts and videos for student users, presenting the content in any sequence preferred. Instructor users can do this by assembling pre-existing content including electronic books and videos. The instructor users can upload additional content created by the instructor such as supplemental textbooks, for as ePub, PDF, or HTML files, or supplemental videos created by the instructor. Each lesson can comprise any format such as chapters, with sub-chapters and paragraphs. Information of each custom course, including information identifying each content element of a course the sequence, is stored in memory. The server can then serve each content element to the student user in the desired sequence as each student progresses through the course. Many content elements, such as videos, text, and electronic books, can be used in multiple courses. Thus, a specific video or electronic book can be used as the curriculum for several courses. Lessons allow educators to combine content from the social learning site and publish the reordered content to meet the educational objectives of their class. Tutorials for viewing by non-students can be formed in same manner as lessons.

The membership database can keep track of member's progress towards completion of lessons (classes), for example videos, books, etc., by storing information identifying the content that the user has started and information of a location or pointer within the content that the user has completed. This can be accomplished by monitoring the pages opened by the user and when the pages were opened and viewed by the user.

The membership database can also store member information regarding connectivity, such as username, password and/or other information required by the applicable social network API to permit the server to post to the social network. Examples of social networking sites include Facebook, LinkedIn, and Twitter, as well as any other social network site. Thus, educational accomplishments and awards can be published to the user's social network if desired. The membership database preferably stores information about all users of the system. Examples of this information includes username, password, name, address, email address, and social networking sites to which the member belongs.

The messaging system permits users to communicate with each via live chatting, email, or any other means. Messaging is provided to share information among users and trusted social friends within the learning platform, or for connectivity to external messaging systems. Instructor users are also able to communicate privately with content authors and with other instructor users, as well as with student users. Student users can communicate with fellow student users or with their instructor users.

The module for live video streaming of classes and seminars comprises hardware and/or software to received video from one instructor user at a first location remote to the sever and broadcast the received video content to a plurality of student users at a plurality of locations remote from the instructor user and server. Live classes are available for streaming and can be recorded or stored and added to the video library. The system's video library system allows for classes to be recorded for playback at a later date.

FIG. 1B illustrates a flow chart of an embodiment of the invention showing how the online learning server (1) is connected to separate digital libraries containing eBooks or digital books (2), videos (3), instructor supplied content (4), and a membership database (5). The digital libraries can be connected to one another and the server (1) over a network. If desired, one or more the digital libraries may be maintained on the server (1).

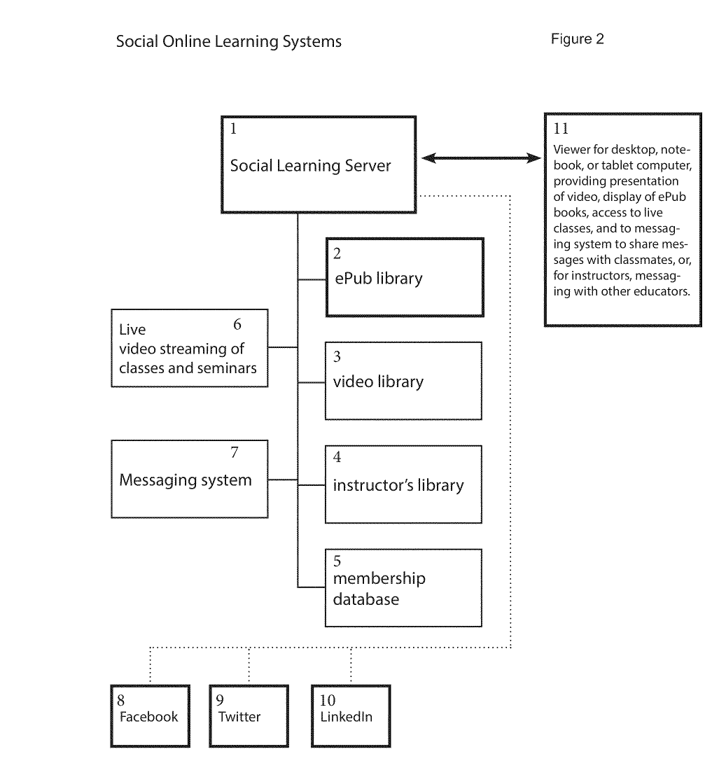

FIG. 2 illustrates a flow chart of an embodiment of the invention showing an Book or digital book from the ePub library (2) being viewed through the social learning server (1) and how the user can choose to share with social networks (8, 9, and 10) the content they have read.

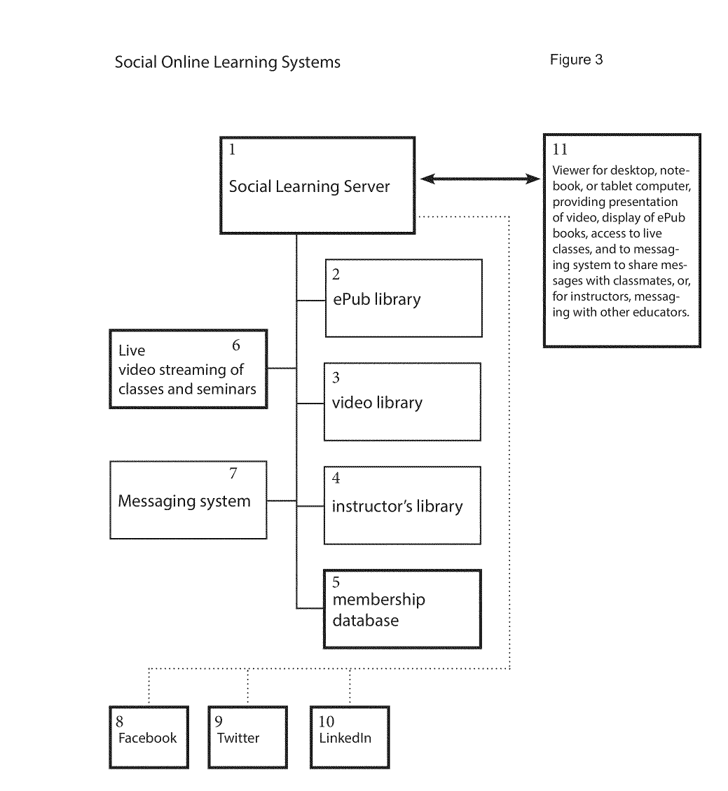

FIG. 3 illustrates a flow chart of an embodiment of the invention showing that when a user (11) has completed a milestone established by the publishers, they can be awarded a virtual award, such as a badge, which can be displayed on their online profile on the site (1) and can also be shared with social networks (8, 9, and 10).

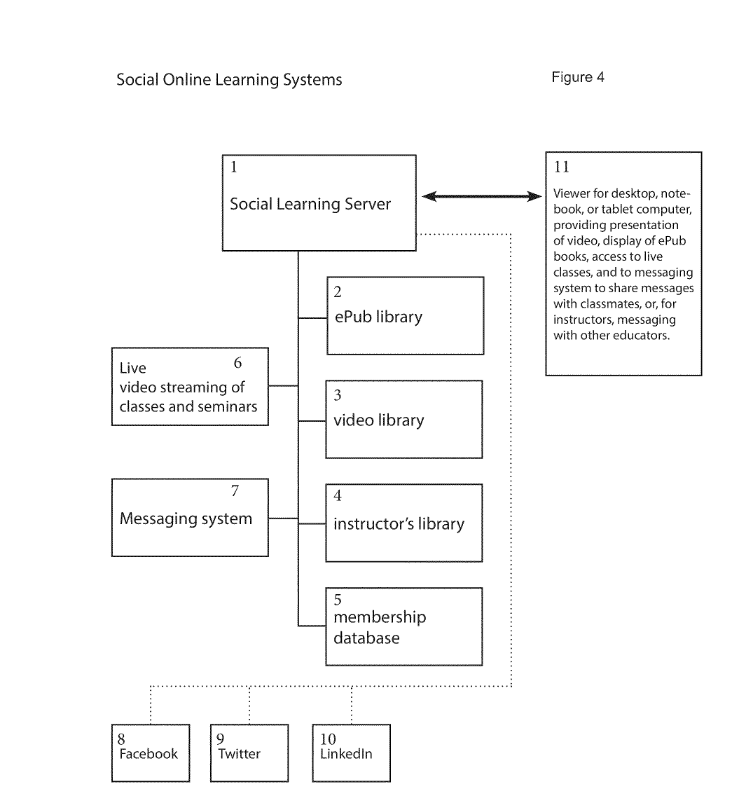

FIG. 4 illustrates a flow chart of an embodiment of the inventions showing that instructor users, teacher users, or other educator user with designated privileges (5) can use the social on-line learning system (1) to create an ordered progression of content to be read and/or viewed in a specific sequence to correspond with learning objectives or a class syllabus defined by the teacher user or instructor user. The instructor user can combine videos and written educational material to create lessons that include content from some or all of the content types contained within the system, including eBooks (2), videos (3), and other content uploaded and provided by the instructor user, teacher user, or educator user in the instructor's library (4).

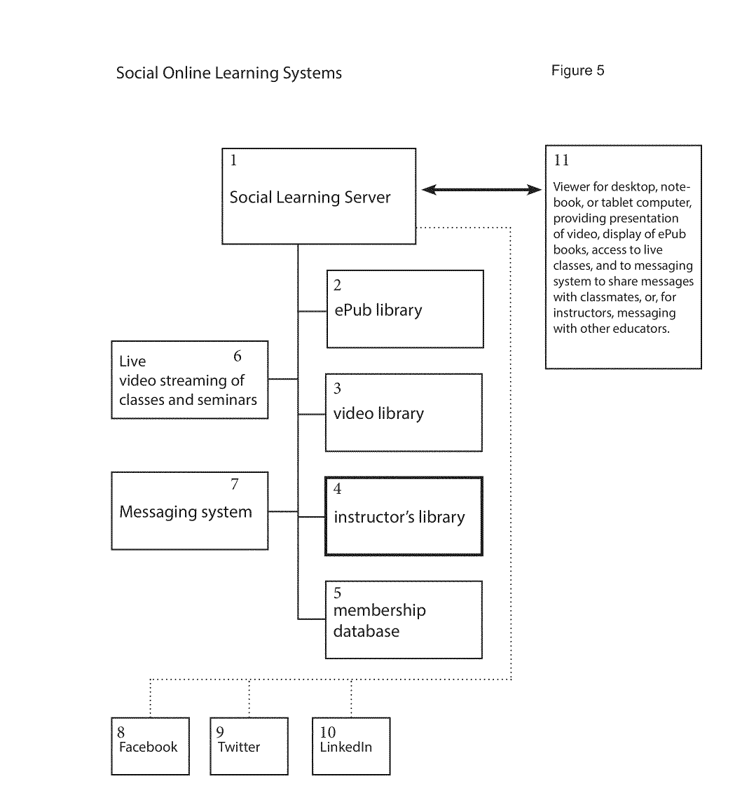

FIG. 5 illustrates a flowchart of an embodiment of the invention showing instructor's library (4) being used to by an instructor user (11) to access additional information for their class. Instructor users are provided additional content such as educational material to help teach the classes, additional background information, additional lesson ideas, along with review questions for student users and exam questions. Instructor users are also able to monitor their class progress through the Social Learning Server (1), and can assign reading and video projects, and confirm that assigned lessons have been accessed by student users. Instructor users are able to create and compile lists of content for students to consume. These can include videos from the video library (3), ebooks from the ePub library (2), and also files they have uploaded into the instructor's library (4). The books can include sections or chapters from various titles, and the videos can involve short clips. For example, an instructor of a Web Design class can assign an HTML video, a Dreamweaver ebook page, and a separate reading in PDF or MS Word format uploaded by the instructor user (11).

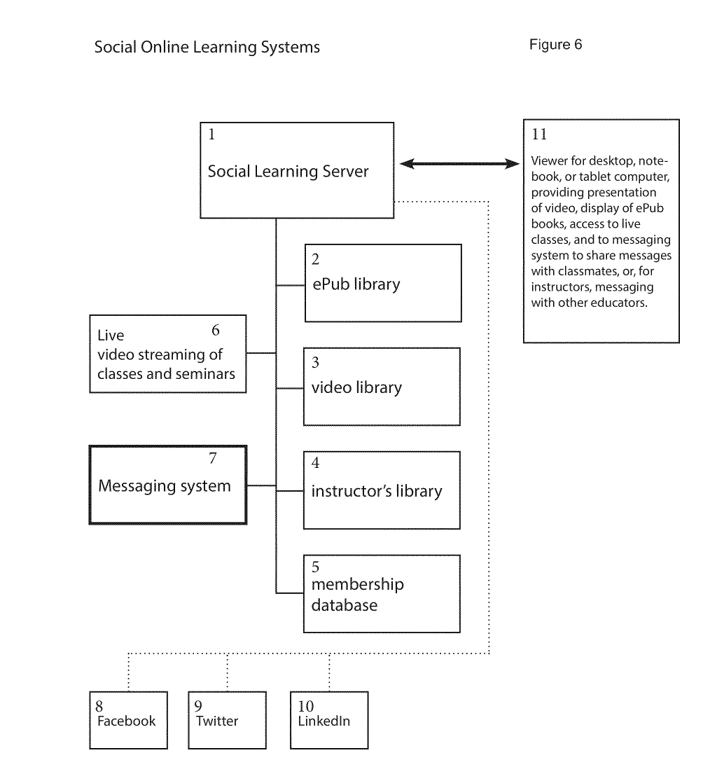

FIG. 6 illustrates a flowchart of an embodiment of the invention showing how student users can read ePubs from the ePub library (2), watch videos from the video library (3), and attend live classes (6) they can exchange messages with both instructor users and fellow student users using the messaging system (7) which is used for exchanging messages among members listed in the membership database (5). All content is accessed and viewed by the user in their web browser either on a desktop computer, notebook computer, or mobile computing device (11).

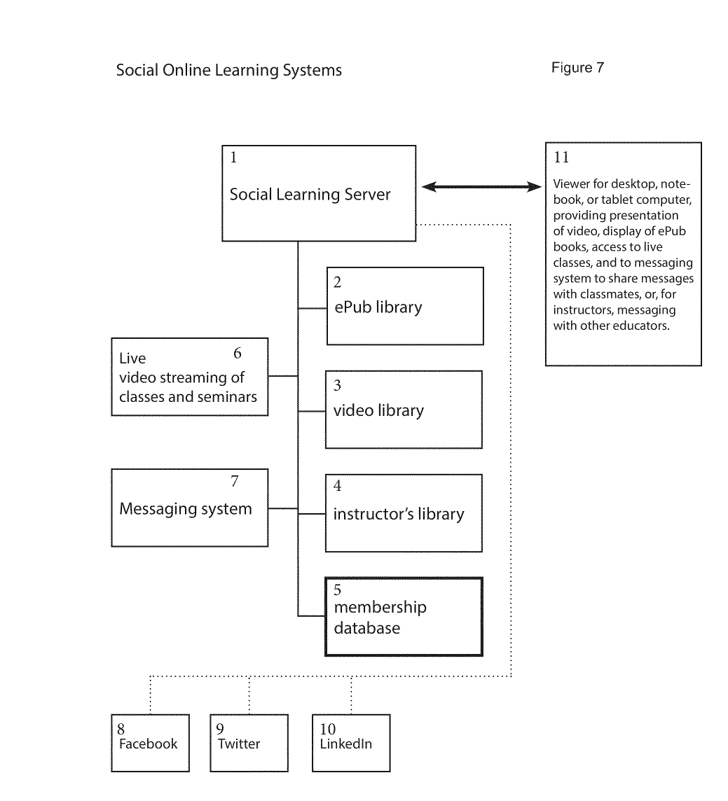

FIG. 7 illustrates a flowchart of an embodiment of the invention showing how the membership database (5) can be used to create groups of instructor users, teacher users, educator users, administrative users, and any other desired group. Groups allow users of the system to share information with colleagues or classmates. Educator users and members of professional associations can start groups that are open and can be joined by everyone or private and open only by invitation, such as only those enrolled in a specific class or attending a specific school using the social learning server (1). These groups can include private classes for sharing class assignments and information between students and between instructors and students. Instructor users can be provided with access to private groups that include authors, curriculum developers, along with fellow educators.

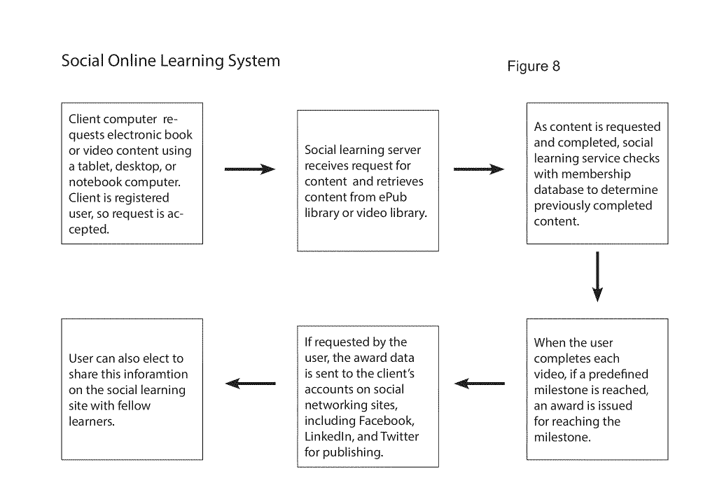

FIG. 8 illustrates a flowchart of an embodiment of the invention showing that as a user completes a lesson or class and achieves a learning accomplishment that has been predefined by the system administrators and stored in the social learning server (1), the accomplishment can be shared internally with other users in the membership database (5) when they log-in to the social learning server (1) or by sending the information regarding the accomplishment to external social networking sites (8, 9, 10). While participating in the online learning environment, a user reaches a milestone in their progress and an award is issued noting the achievement. The user can then share this achievement with friends on external social networking sites and internally within the learning network to denote their learning progress. Accomplishment can also be shared on users profile within the Social Online Learning System, displaying as a badge or progress bar to denote accomplishments.

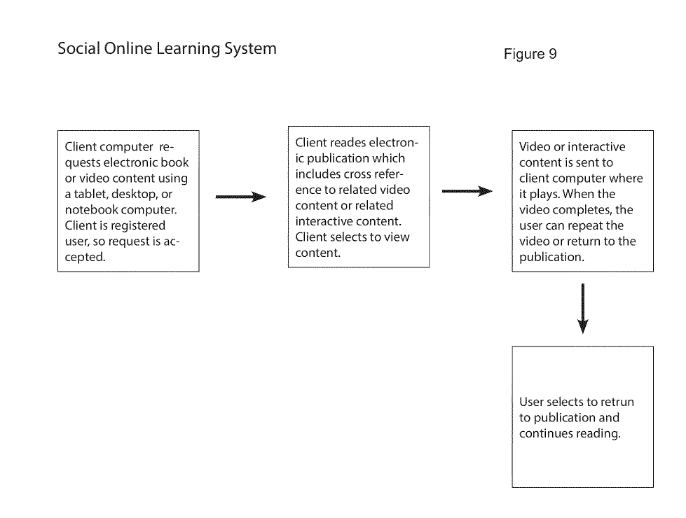

FIG. 9 illustrates a flowchart of an embodiment of the invention showing that the learning system (1) generates and displays references to related content (2, 3, 4) as other content is read or viewed on the user device (11). This flowchart illustrates, by example, how a user reading an electronic publication is informed of a reference to video content that relates to the content in the publication. The user is able to view the related content on the user device (11) and then return to reading the publication.

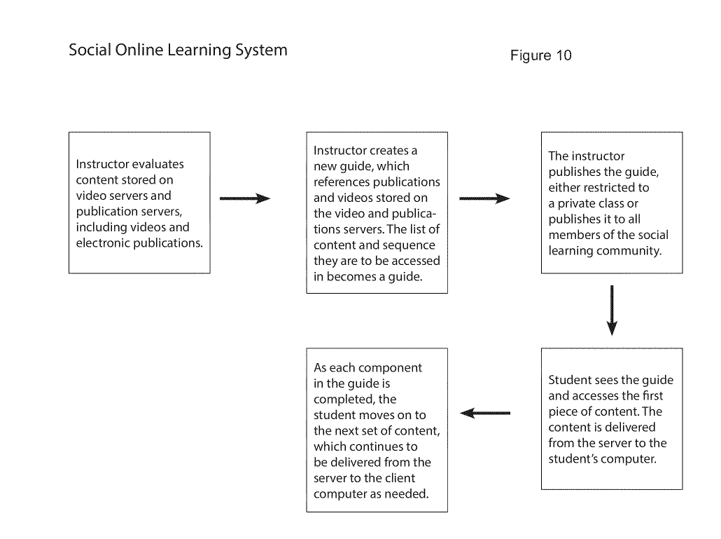

FIG. 10 illustrates a flowchart of an embodiment of the invention showing an instructor user (11) who has accessed the system assembling content to create a lesson, which is saved in the instructor's library (4). The instructor user accesses the social online learning system to assemble content of various types and formats (2, 3, 4) into an organized group of modules with a progression and sequence defined by the instructor user. Content from various books and video sources can be included, and the instructor user can add their own content as well. This assembled content can being called a tutorial (generally used for non-students), lesson (generally used for students), class, or other as desired. Student users then access the lesson and progress through the content in the sequence defined by the instructor user. The content remains in its respective locations (2, 3, 4) when it is added to the lesson and the sequence or progression of content through the lesson can be stored in the instructor's library (4).

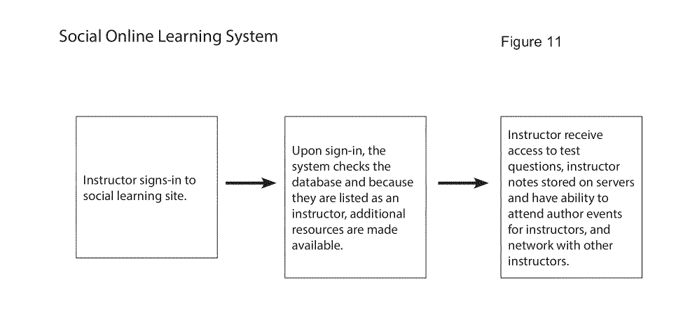

FIG. 11 illustrates a flowchart of an embodiment of the invention in which instructor users interact with authors, subject matter experts, and other instructor users (4, 5, 7). Instructor users who are logged into the system (100) receive access to additional resources including instructor's notes, lecture notes, test questions (4), and ability to interact directly with textbook authors and other educator users (7, 5).

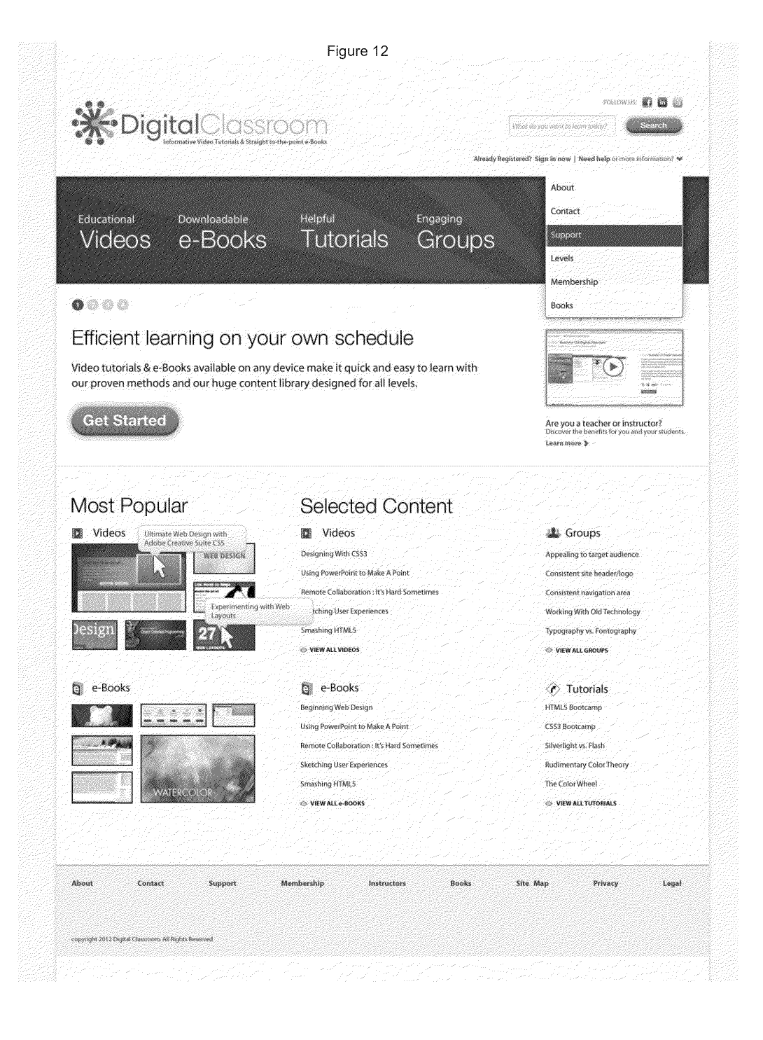

FIG. 12 illustrates the social online learning site as experienced by the user.

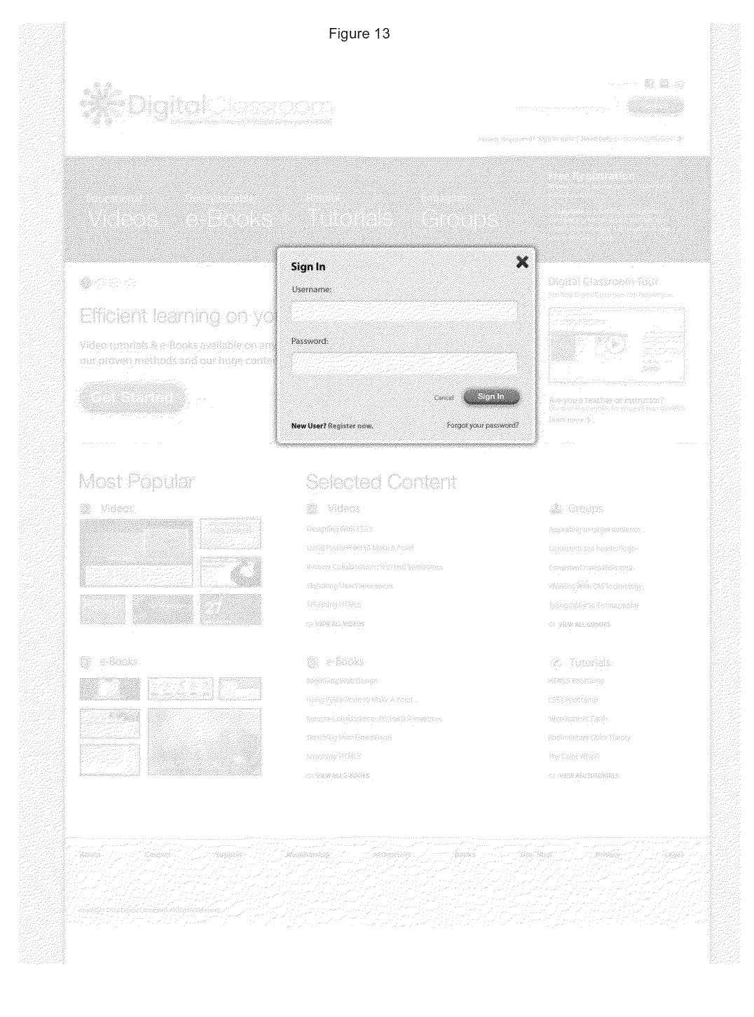

FIG. 13 illustrates a user signing into the social online learning site as membership is required for full access to all services and content.

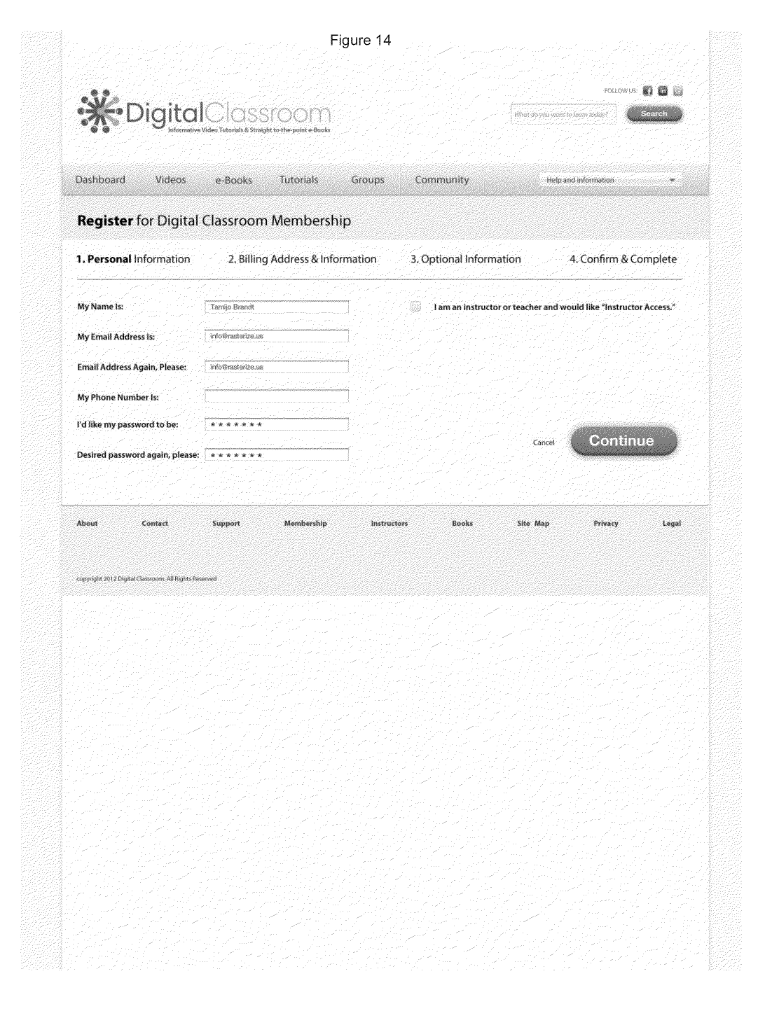

FIG. 14 illustrates a user joining the social online learning site.

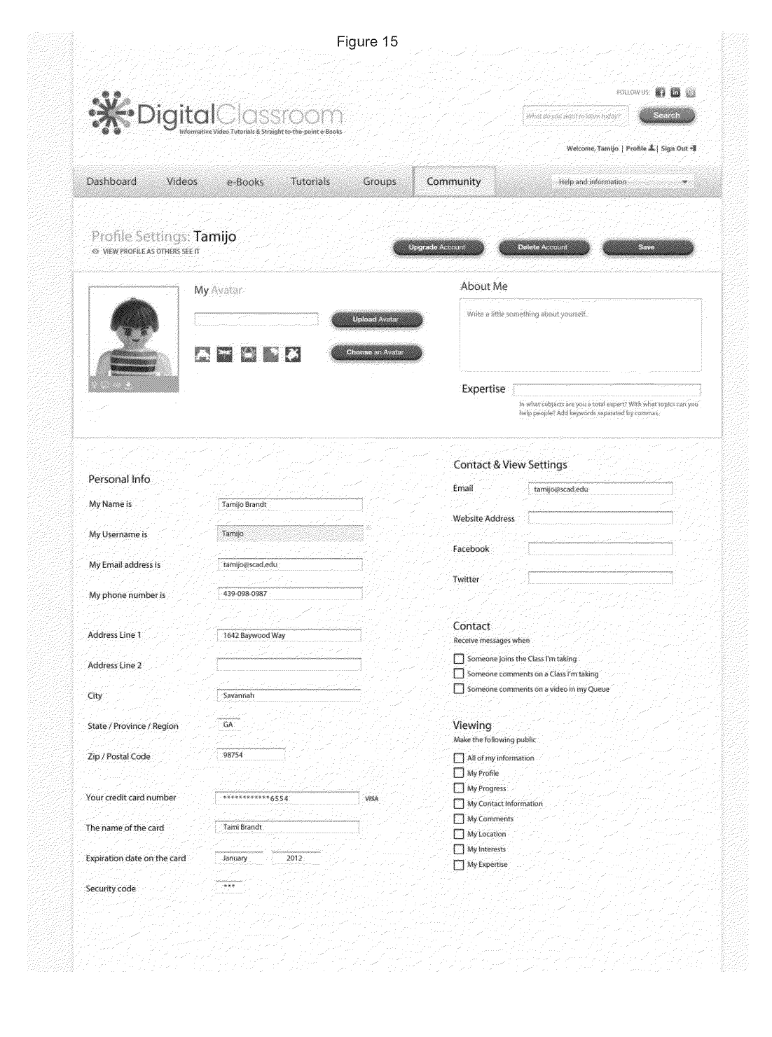

FIG. 15 illustrates when joining the social online learning site that a user can enter information about themselves to share with other users and can upload a picture or an avatar to represent themselves to other users of the system.

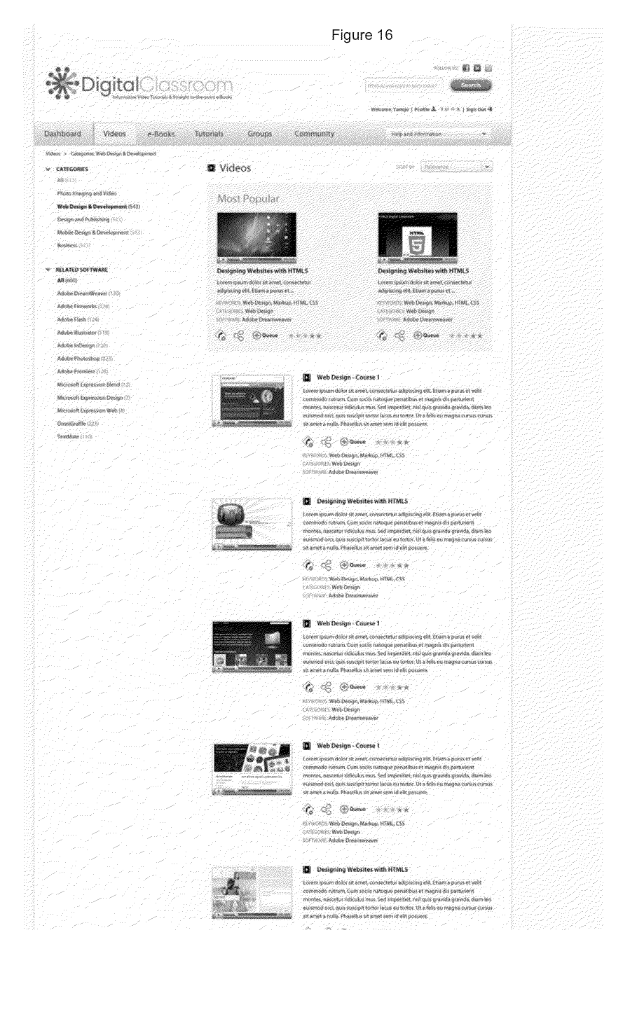

FIG. 16 illustrates that after a user has logged-in to the system they can access a comprehensive library of videos that correspond to topics for which there are also eBooks.

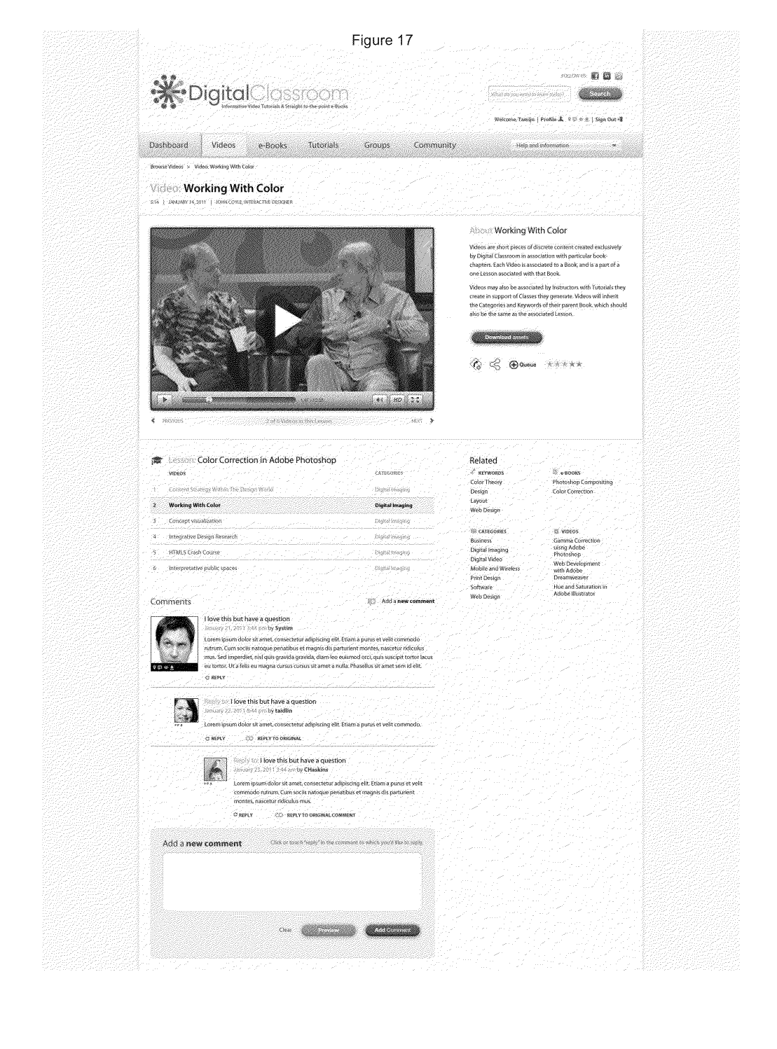

FIG. 17 illustrates that after a user has logged-in to the system they can access individual videos that have been organized into a pedagogical sequence that allows the user to progress through each video in a logical order.

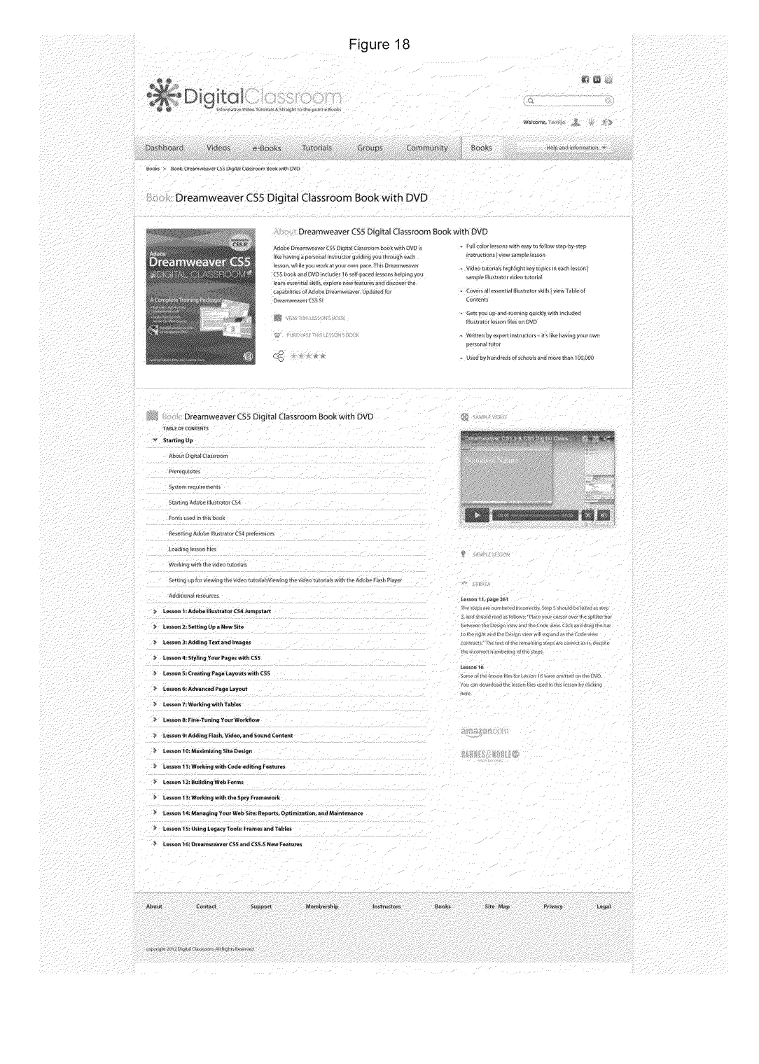

FIG. 18 illustrates that after a user has logged-in to the system they can access individual eBooks that are part of a comprehensive library that corresponds to topics for which there are also videos.

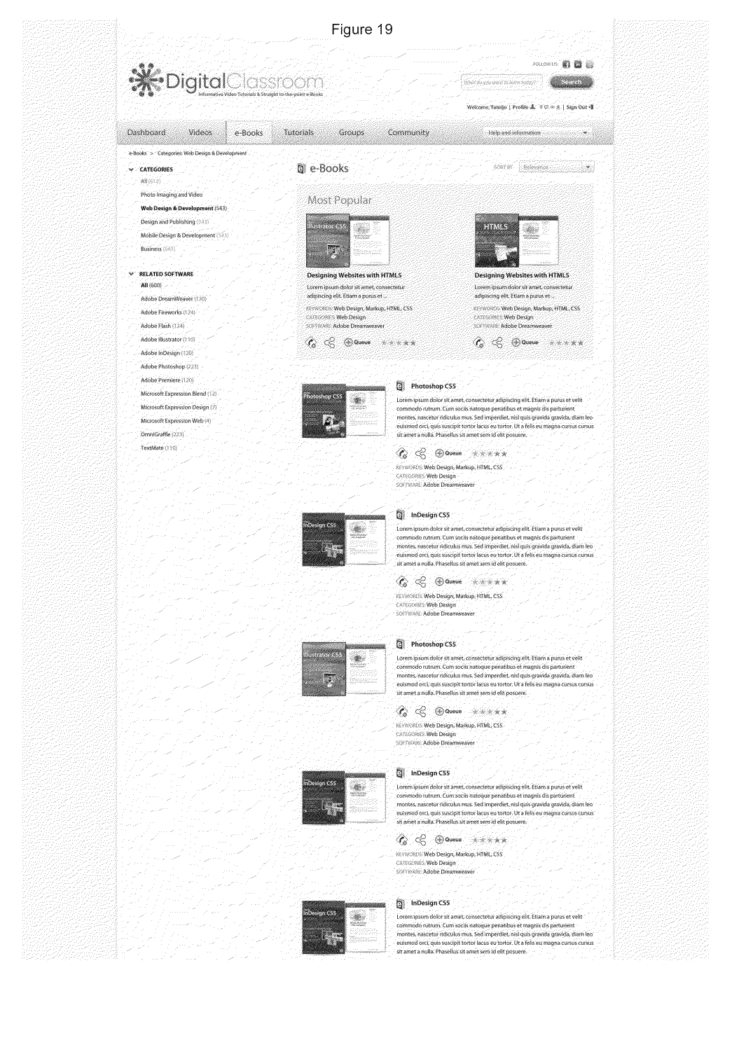

FIG. 19 illustrates that after a user has logged-in to the system they can access a comprehensive library of eBooks that correspond to topics for which there are also videos.

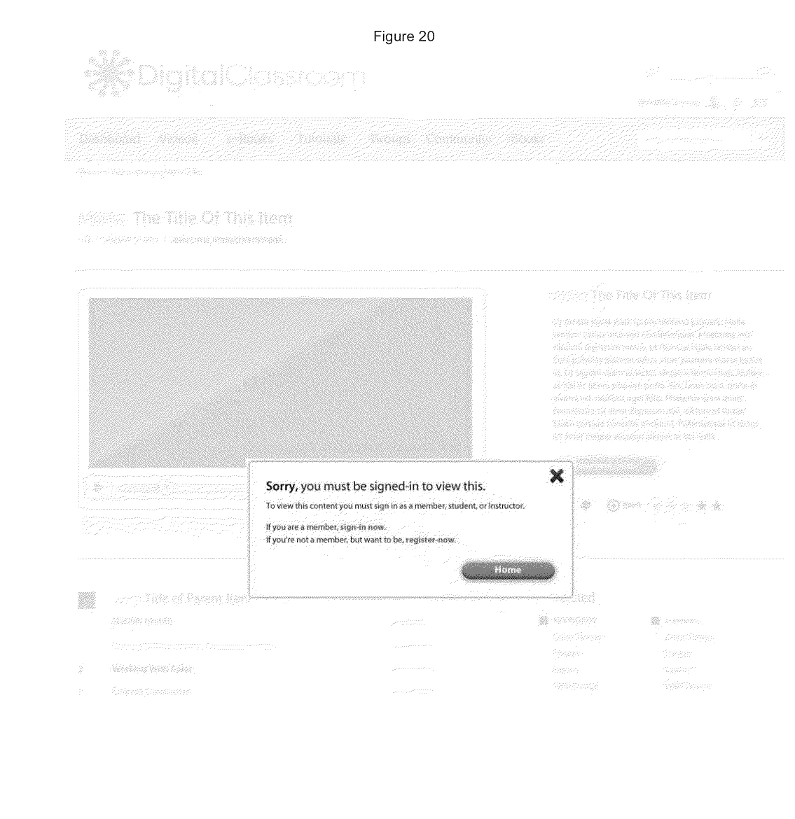

FIG. 20 illustrates that if a user attempts to access specific videos or eBooks and is not a member, they will not be able to access the complete content and will first need to join the system prior to being allowed to access the content.

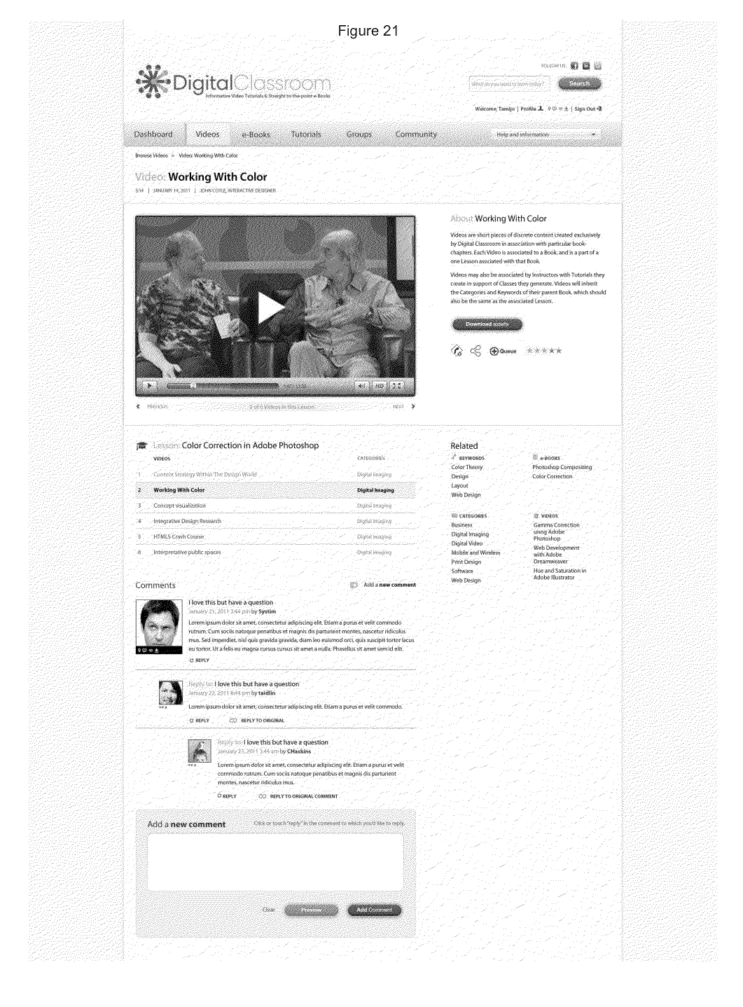

FIG. 21 illustrates that when a user is watching a video or reading an eBook they can post comments for other members or create comments to be shared on external social networking sites.

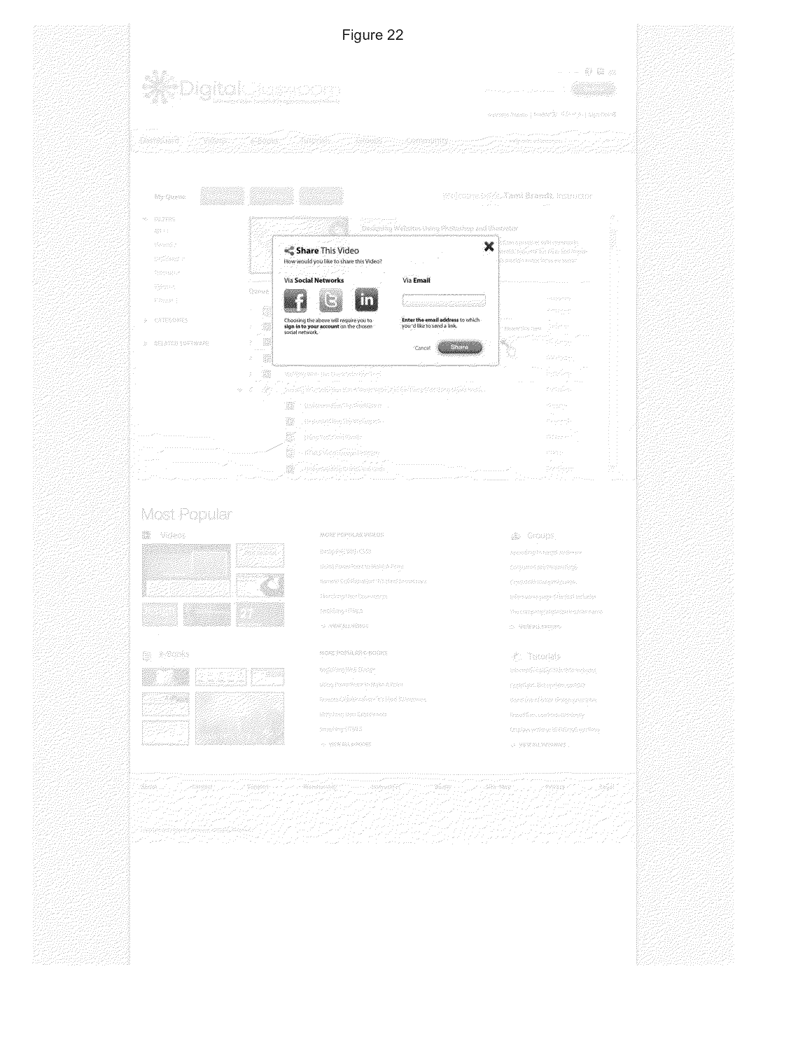

FIG. 22 illustrates that when a user is watching a video or reading an eBook they can share a link to the comment with users who are not on the site. The sharing can occur via an electronic mail message or via a social networking site.

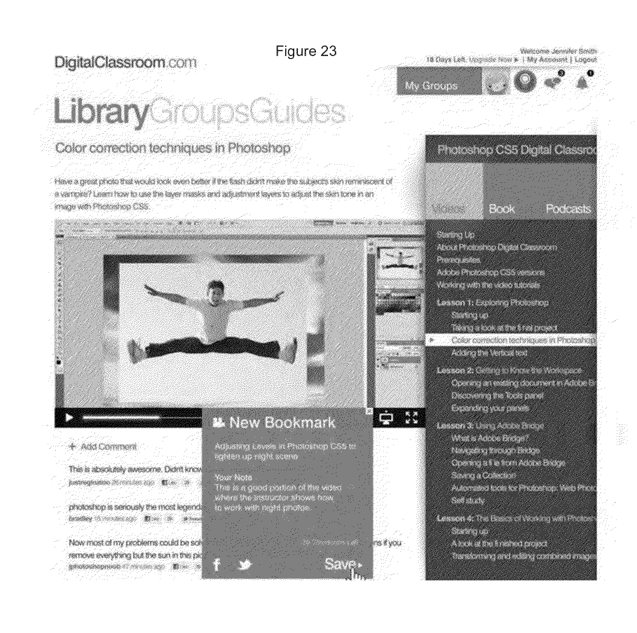

FIG. 23 Illustrates that when reading eBooks, bookmarks of locations where the user would like to return or reference at a future time or share with others can be created. The bookmarks can be shared with other users of the system or non-members.

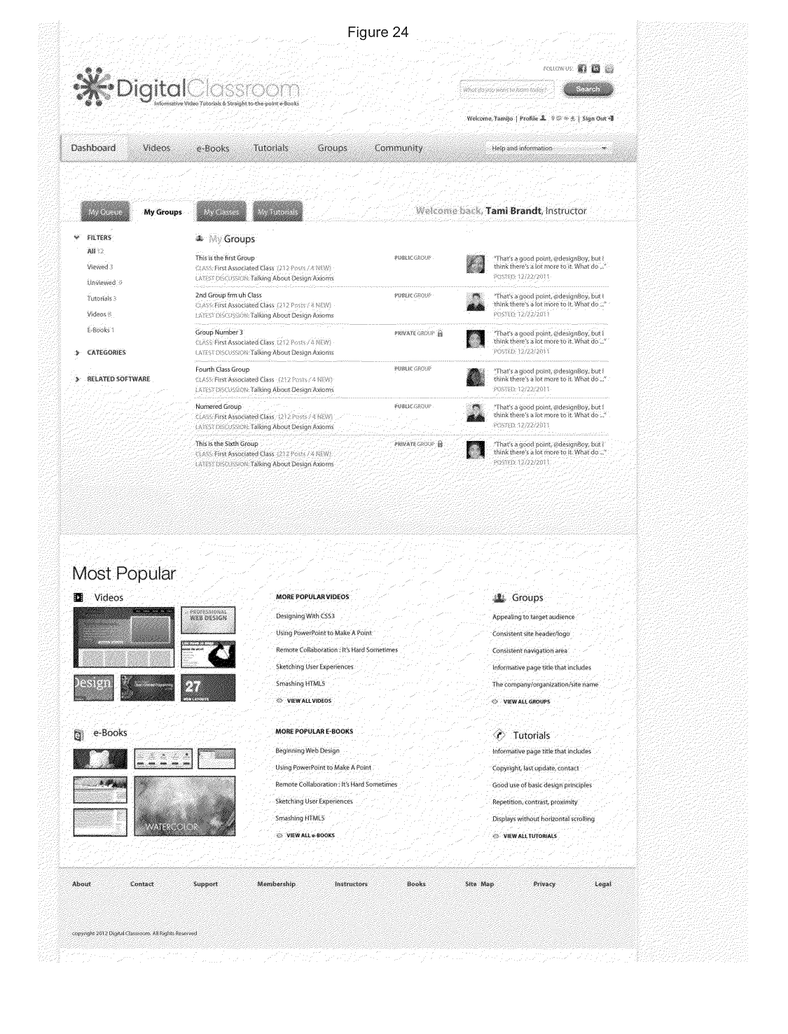

FIG. 24 illustrates that users logged into the system can access groups to which they have been invited to join, including classes in which they are enrolled.

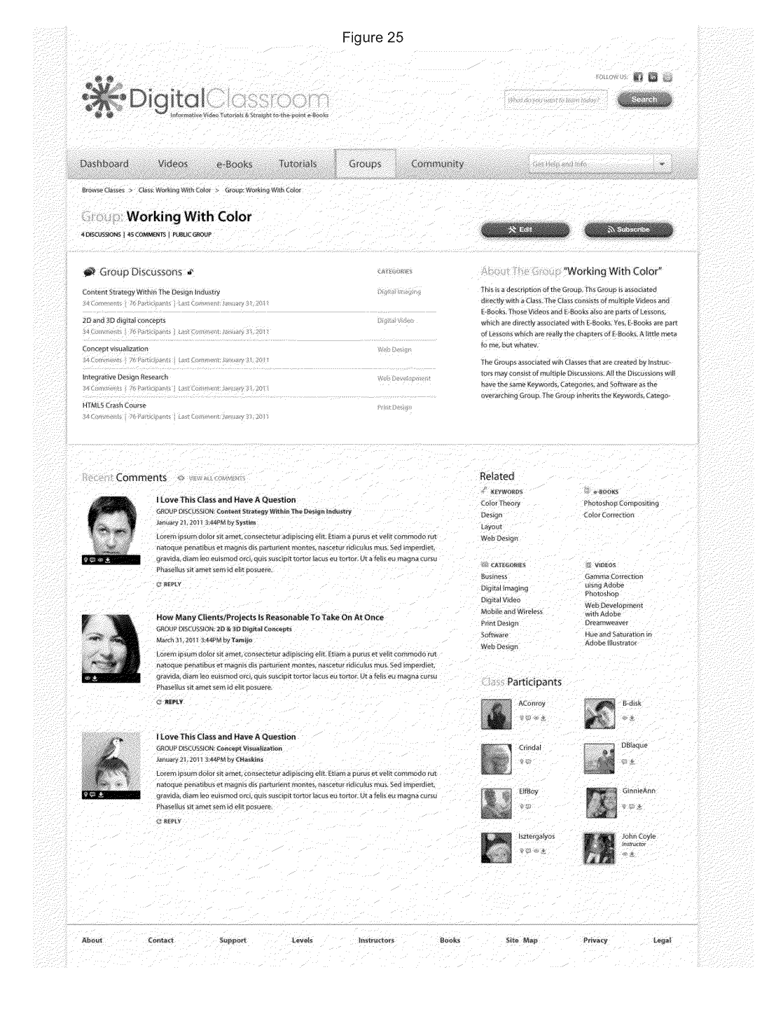

FIG. 25 illustrates that users logged into the system can access groups to which they have been invited to join, including classes in which they are enrolled.

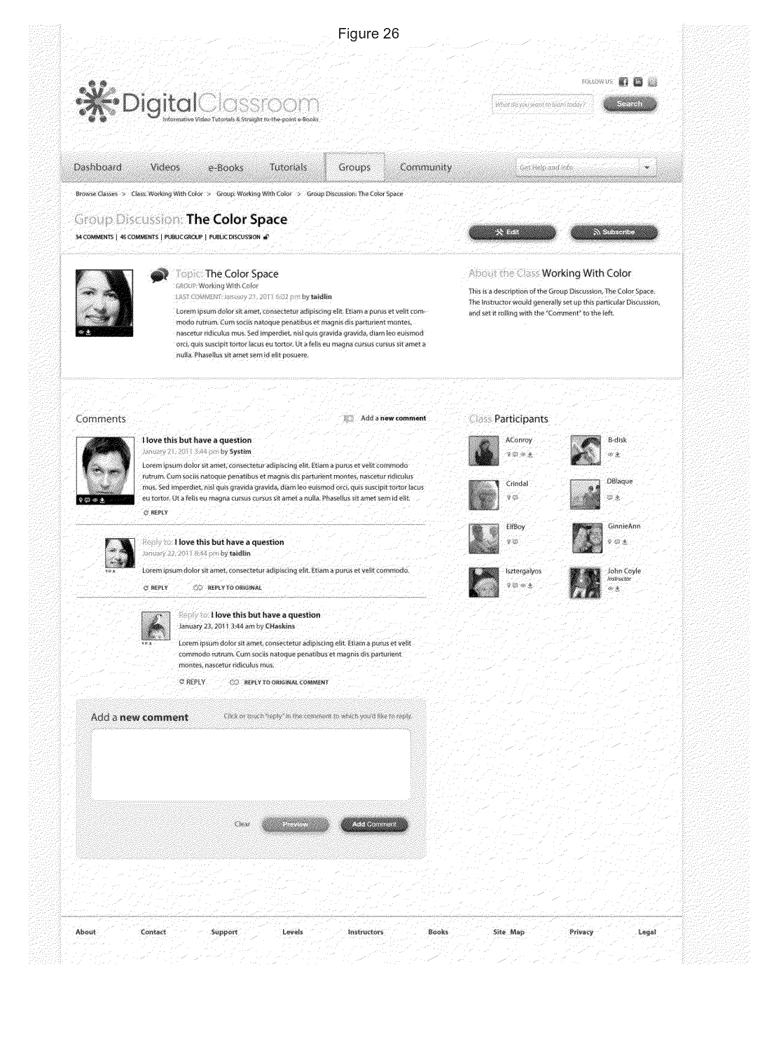

FIG. 26 illustrates that users logged into the system can share messages and conduct online discussions with members of groups to which they belong.

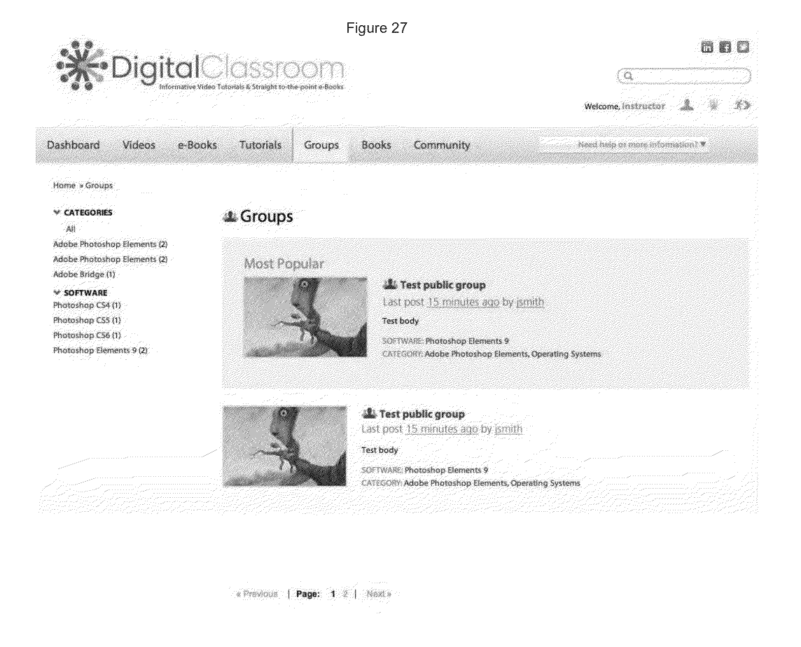

FIG. 27 illustrates that groups to which a user belongs can be viewed to display groups with the most activity, such as messages within the group.

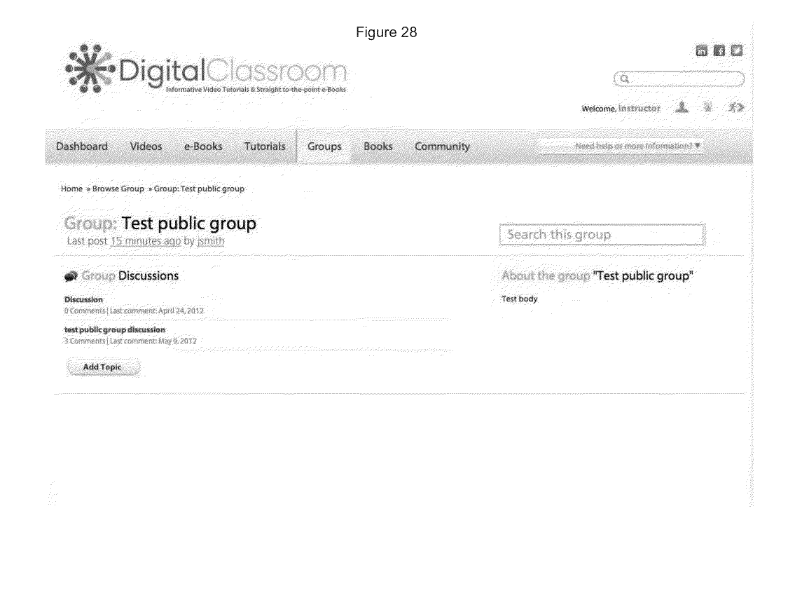

FIG. 28 illustrates that once a user is logged-in, they can create new topics for discussion with the groups to which they belong.

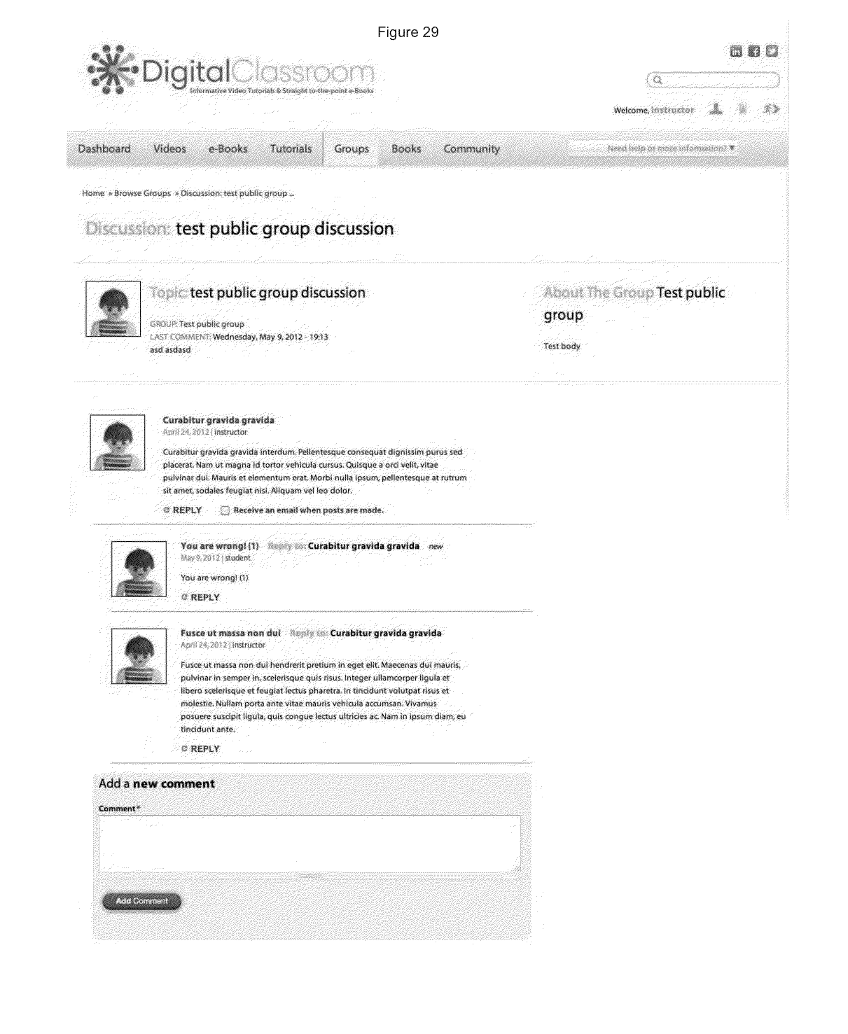

FIG. 29 illustrates that once logged-in a user can access groups to which they have been invited to join, including classes in which they are enrolled. Groups discussions can be set to be private and only viewed among members of a specific group.

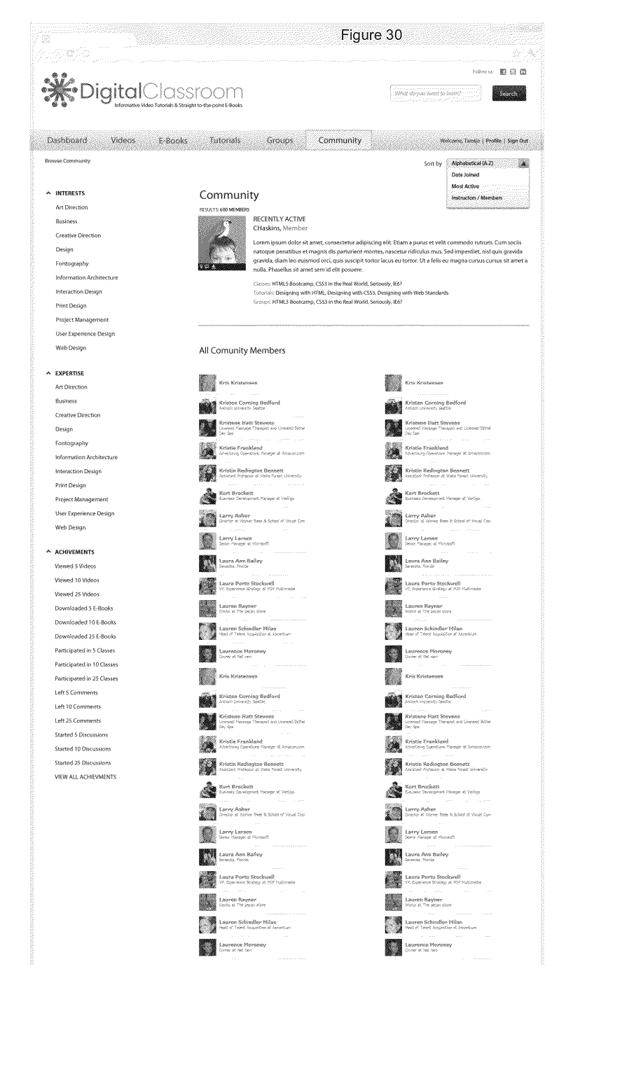

FIG. 30 illustrates that users can locate and identify others members on the site with specific interests or skills for the purpose of sharing information, answering questions, and discussing learning strategies.

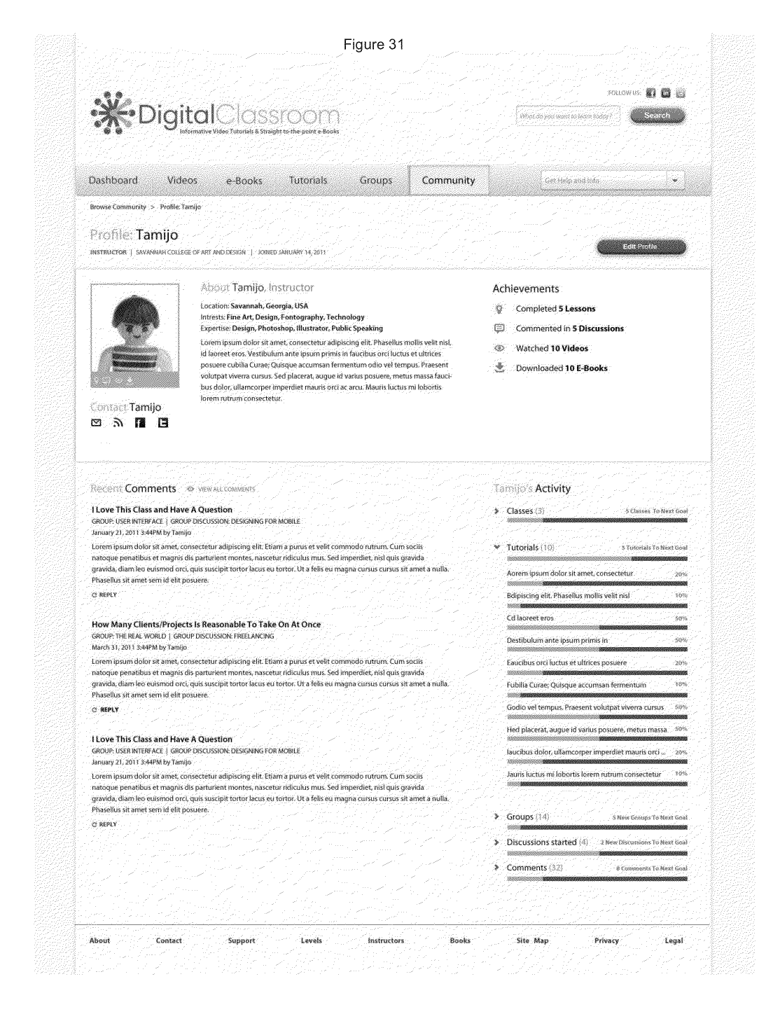

FIG. 31 illustrates that when lessons and classes are completed, awards are provided and they can be shared with group members or with external social networks.

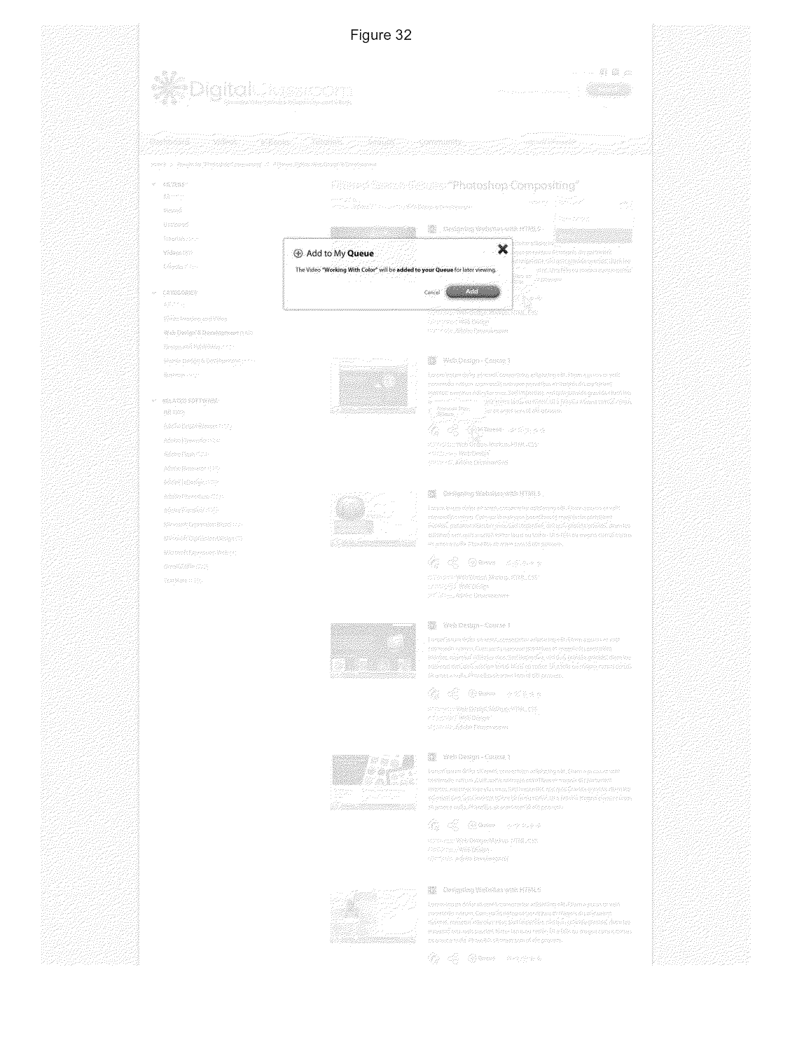

FIG. 32 illustrates that registered users who are logged-in to the system can create a list of lessons and books to consume later by placing it into a queue. The queue is a list of videos, eBooks, eBook chapters, or other educational content from the system that is organized by the registered user for later viewing or reading.

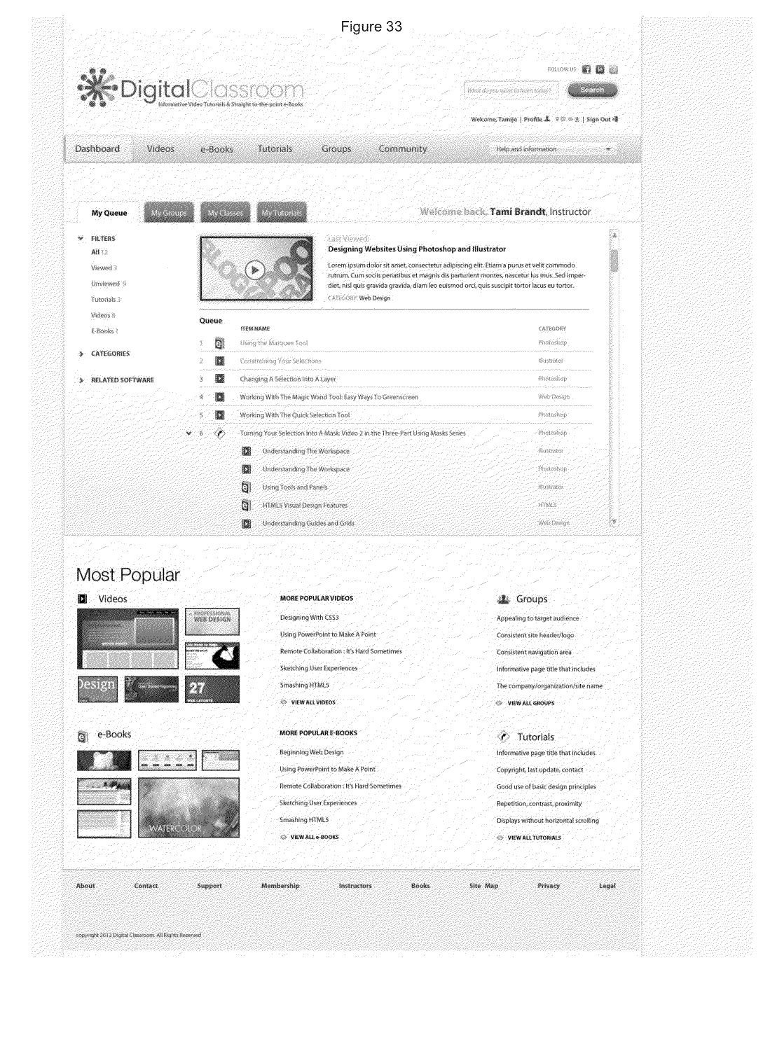

FIG. 33 illustrates the content queue, or list of educational content, to be consumed by the user at a later time. The user can add content to the queue by selecting content from the content library and tagging it to be viewed or read at a later time. Instructors can also assign content to the queue of students enrolled in classes they are teaching.

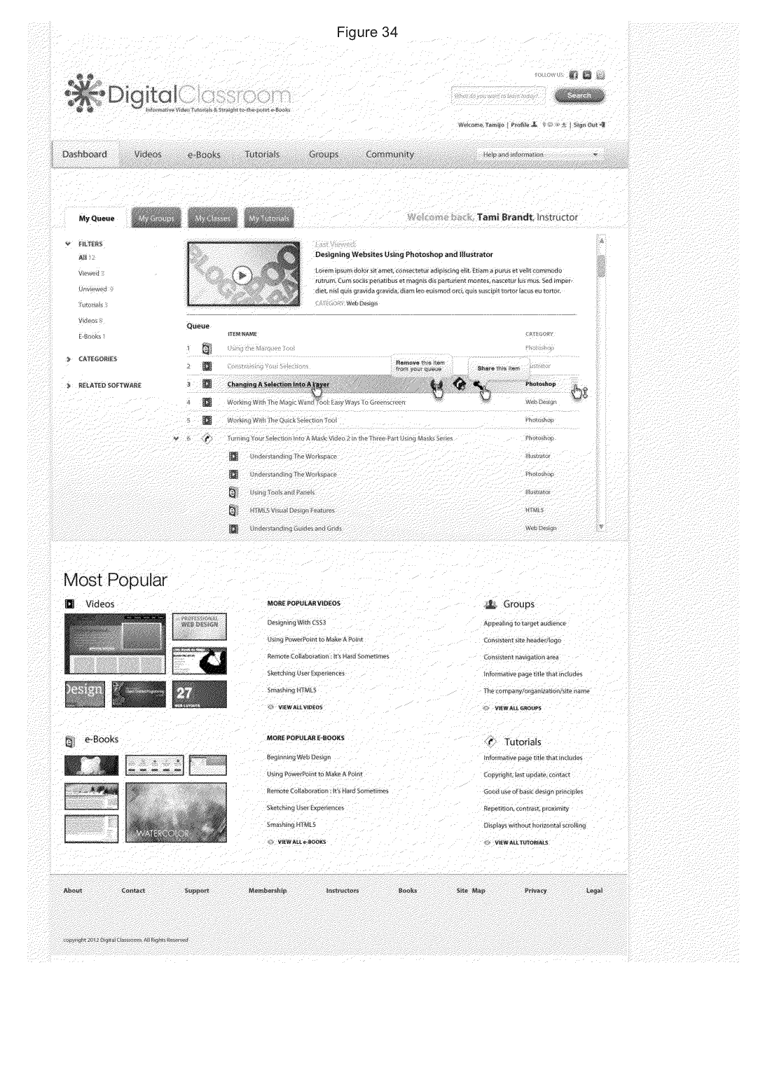

FIG. 34 Illustrates the queue of content, including videos, eBooks, and tutorials or lessons that a user has saved to be viewed or read at a later time. The content was added to the queue by the registered user by selecting content from the content library and tagging it to be viewed or read at a later time. The content can have also been added to the queue by an instructor of a class in which the user is enrolled.

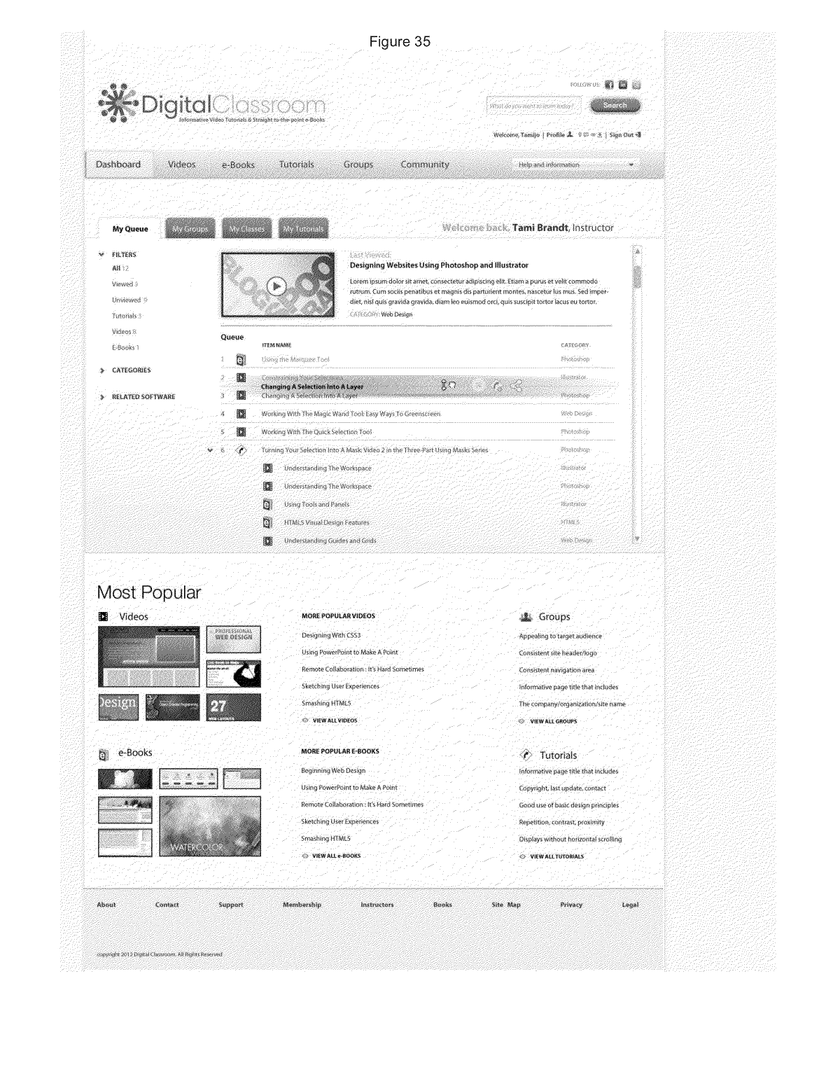

FIG. 35 illustrates that the sequence of the content in the user's queue can be adjusted by dragging the items up or down within the list to change the location of content within the queue.

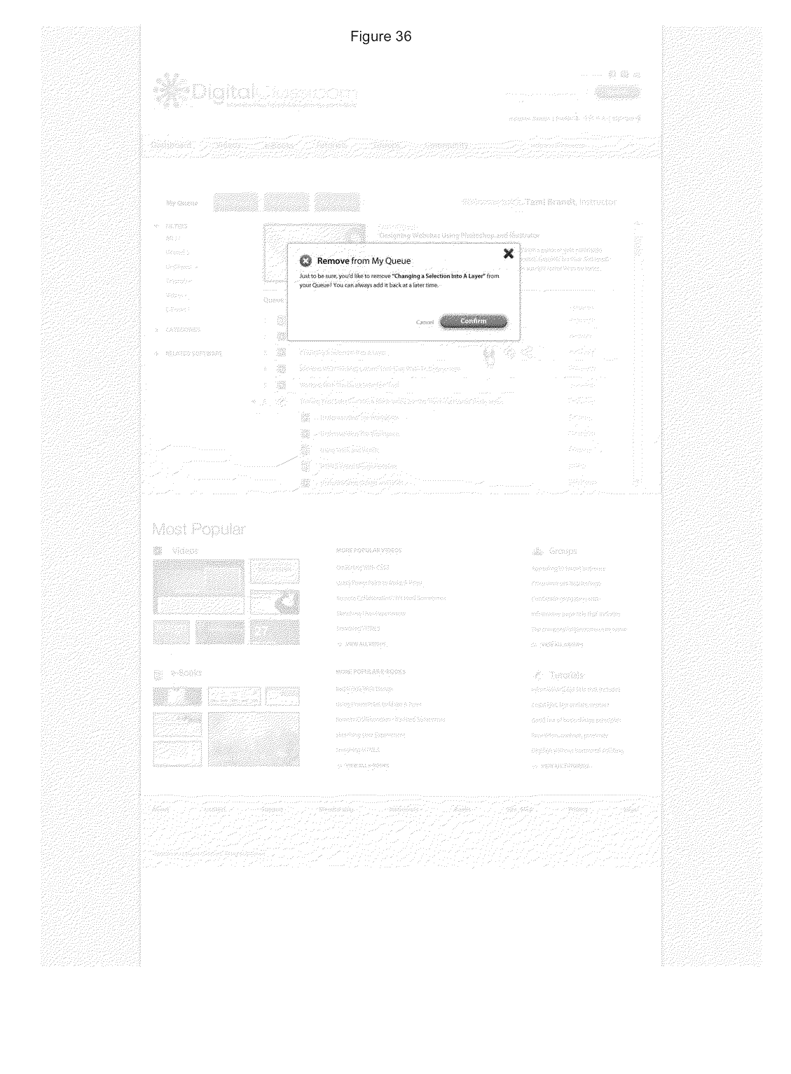

FIG. 36 illustrates how users can remove items from their queue of tutorials or lessons, videos, and eBooks.

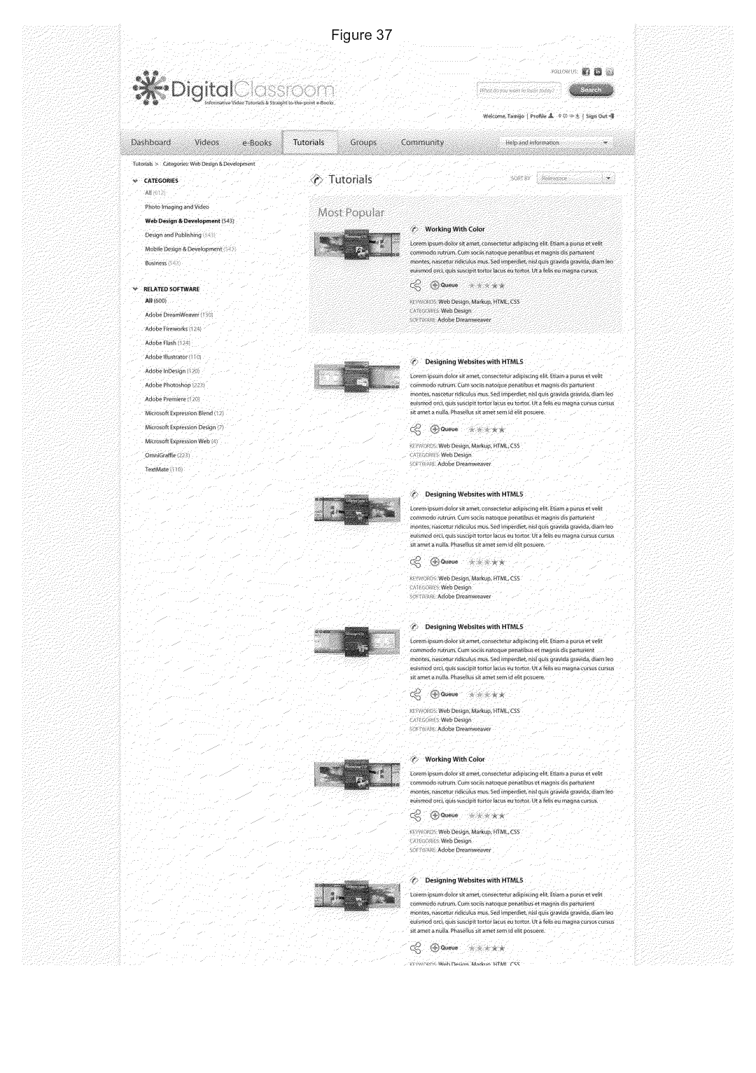

FIG. 37 illustrates how instructor users can combine pieces of content into tutorials or lessons. Tutorials or lessons are created by instructor users or designated users and can be a combination of eBooks, eBook chapters, or videos that are assembled in a custom sequence by the instructor user or designated user to be shared with student users or other users to help them learn a particular skill or concept.

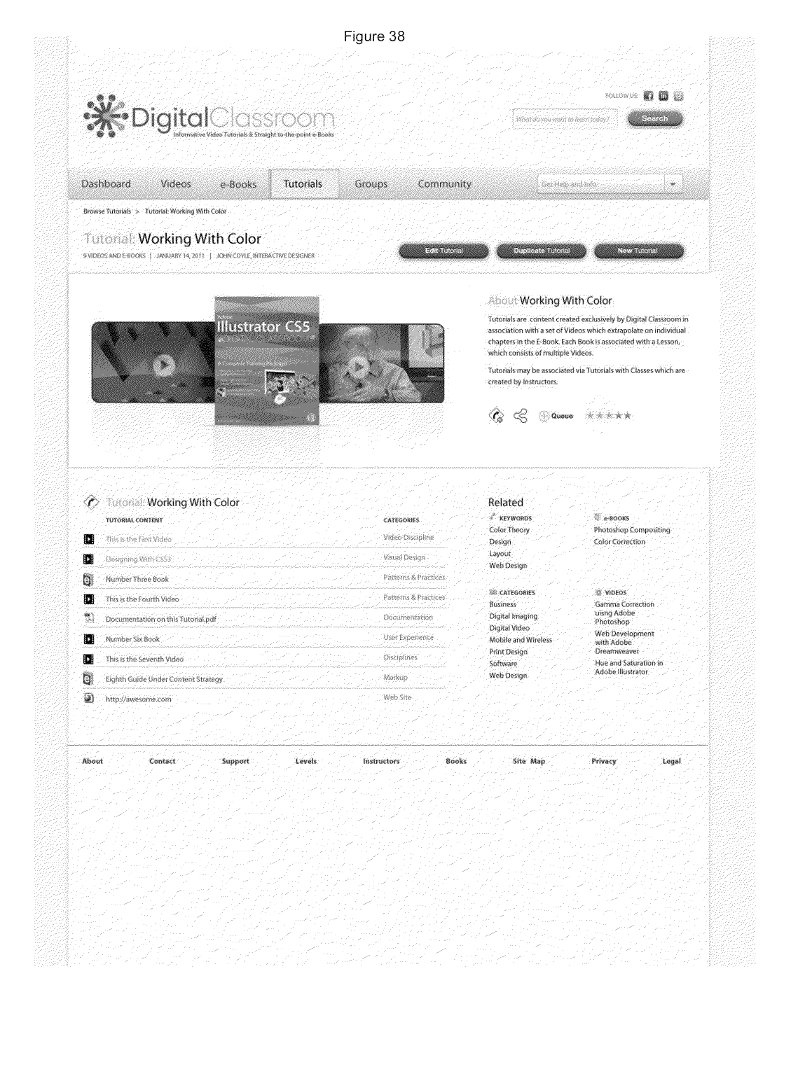

FIG. 38 illustrates a how a user will experience a tutorial created by an instructor user or designated user. In this illustration of a tutorial, the user is able to view videos, eBook chapters, and content provided by the instructor user.

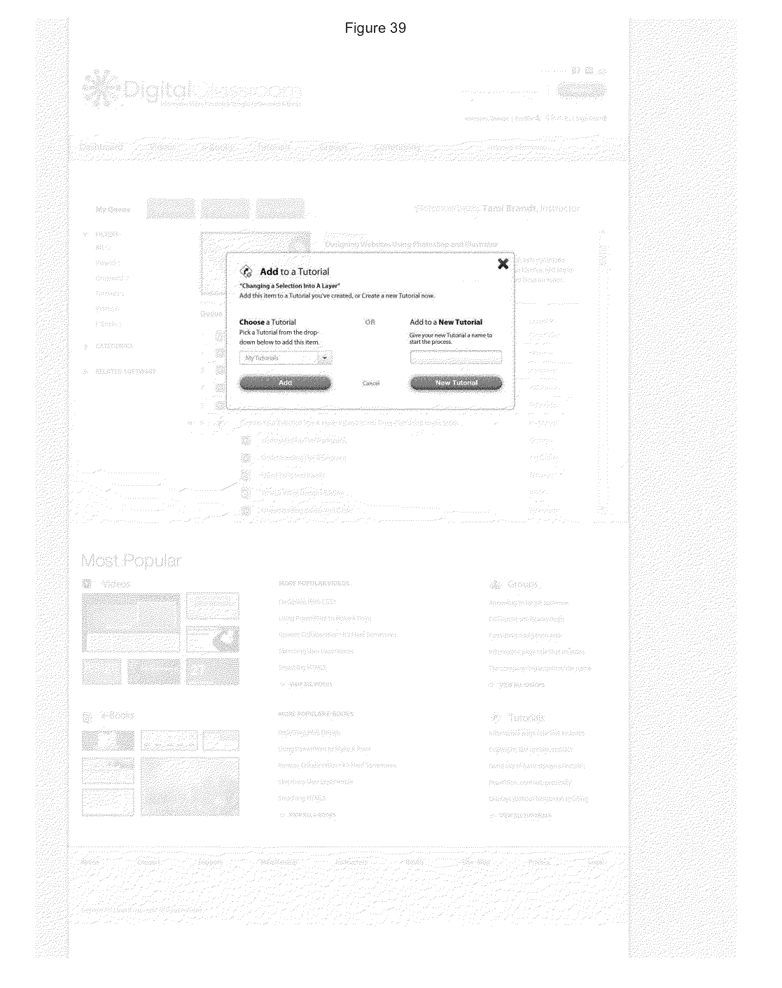

FIG. 39 illustrates how instructor users or designated users can add content into a tutorial.

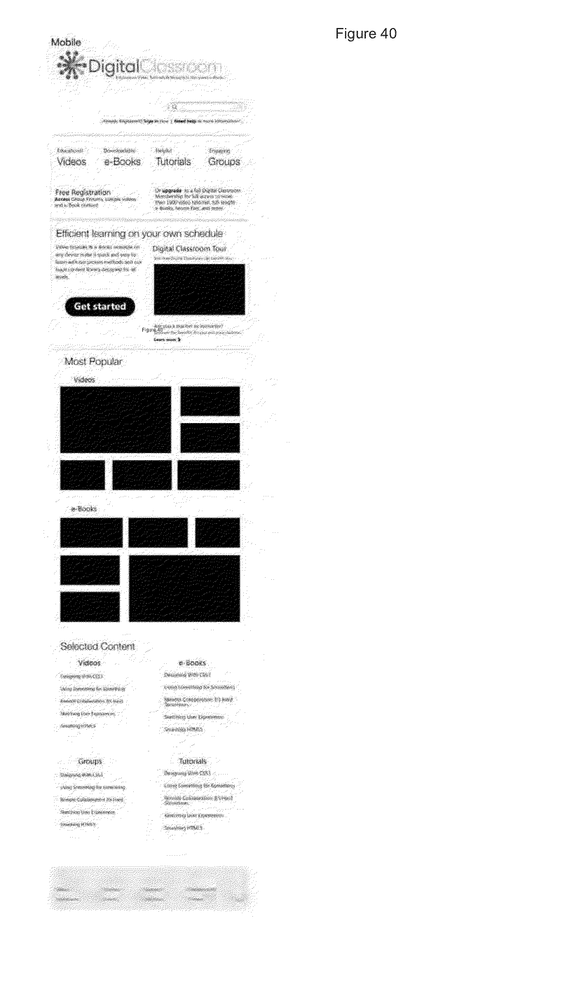

FIG. 40 illustrates that the educational content from the social online learning site can be accessed on multiple platforms and user devices (11), and that the layout and presentation of the site adapts and is optimized to the type of device being used to access the site, view videos, or read the eBooks. More specifically this illustrates the main page of the site as viewed on a mobile device (11), such as a smartphone.

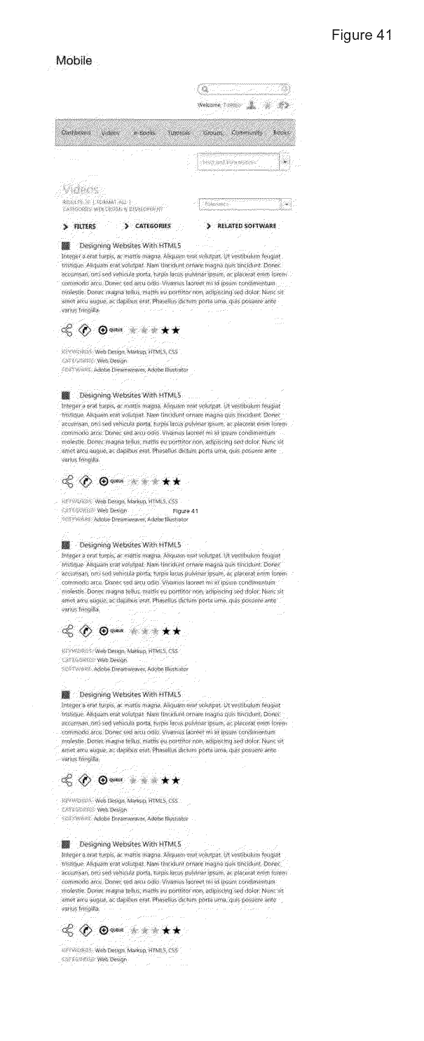

FIG. 41 illustrates that the educational content from the social online learning site can be accessed on multiple platforms and user devices (11), and that the layout and presentation of the site adapts and is optimized to the type of user device (11) being used to access the site, view videos, or read the eBooks. More specifically this illustrates how a registered user can view a list of available videos on the site.

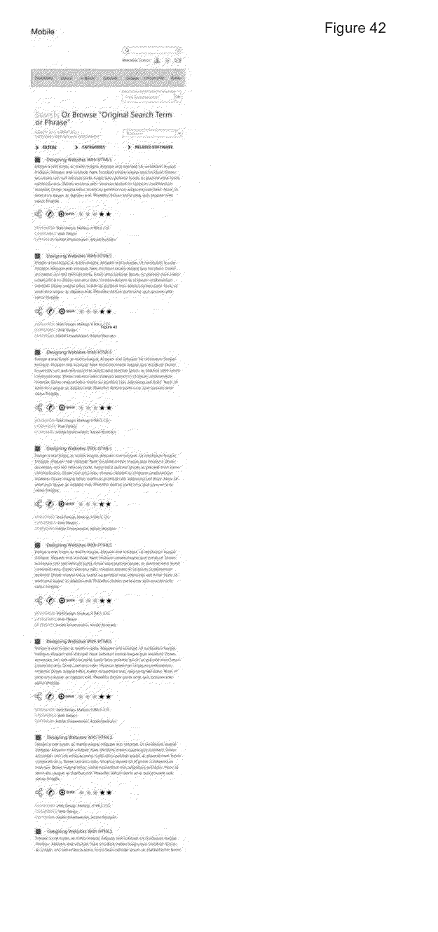

FIG. 42 illustrates that the educational content from the social online learning site can be accessed on multiple platforms and user devices (11), and that the layout and presentation of the site adapts and is optimized to the type of device being used to access the site, view videos, or read the eBooks. More specifically this illustrates a user searching for specific content while accessing the site using a mobile user device (11).

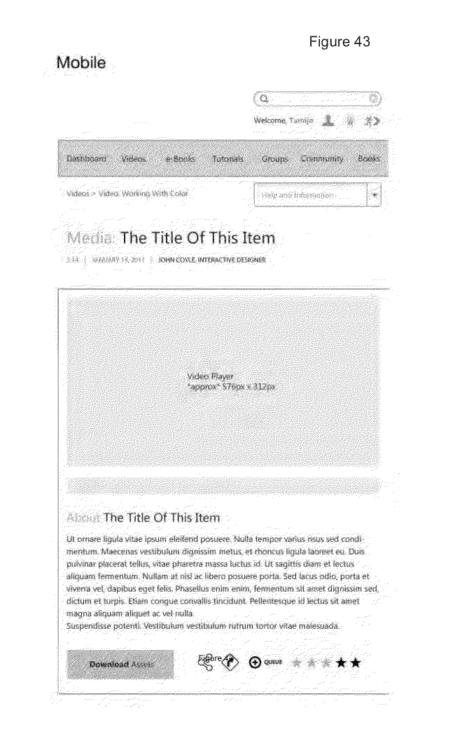

FIG. 43 illustrates that the educational content from the social online learning site can be accessed on multiple platforms and user devices (11), and that the layout and presentation of the site adapts and is optimized to the type of device being used to access the site, view videos, or read the eBooks. More specifically this illustrates an individual video page as experienced by a registered user.

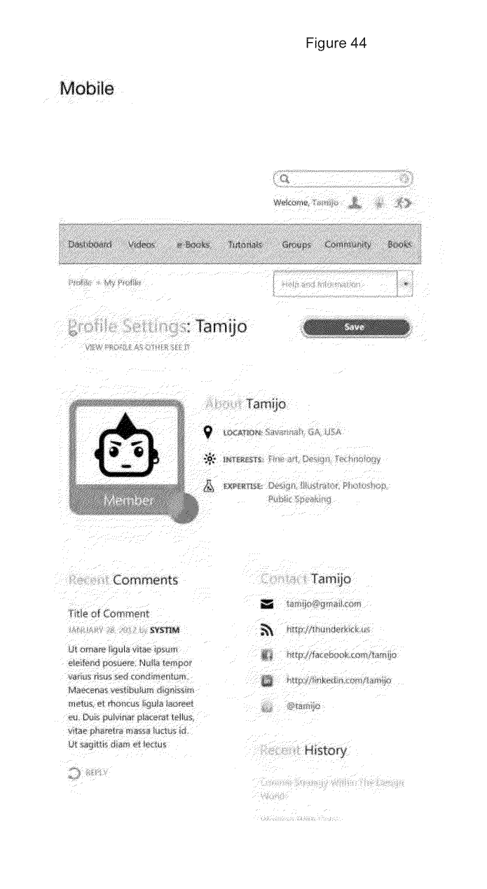

FIG. 44 illustrates that the educational content from the social online learning site can be accessed on multiple platforms and user devices (11), and that the layout and presentation of the site adapts and is optimized to the type of device being used to access the site, view videos, or read the eBooks. More specifically this illustrates a registered user of the site accessing their own individual profile settings from a mobile user device (11).

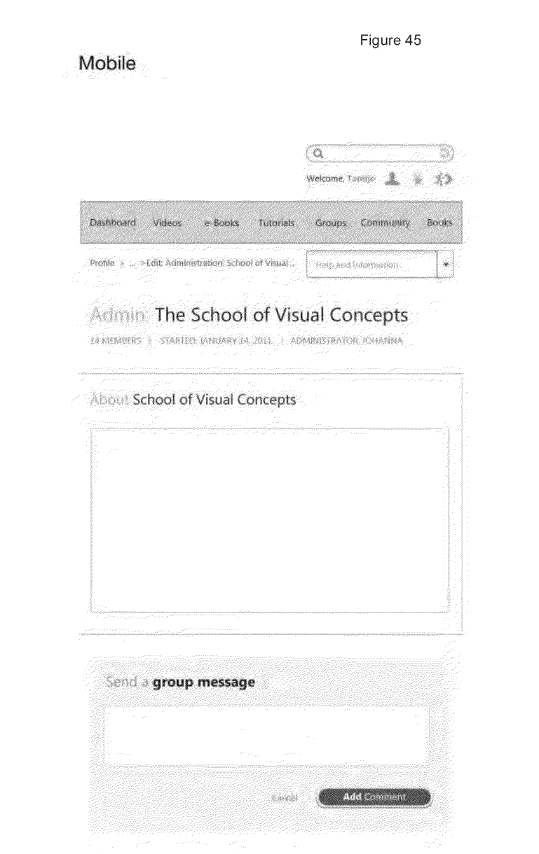

FIG. 45 illustrates that the educational content from the social online learning site can be accessed on multiple platforms and user devices (11), and that the layout and presentation of the site adapts and is optimized to the type of device being used to access the site, view videos, or read the eBooks. More specifically this illustrates a school administrator viewing the site from their mobile device and being able to administer their school or class settings or contact members of the school from their mobile user device (11).

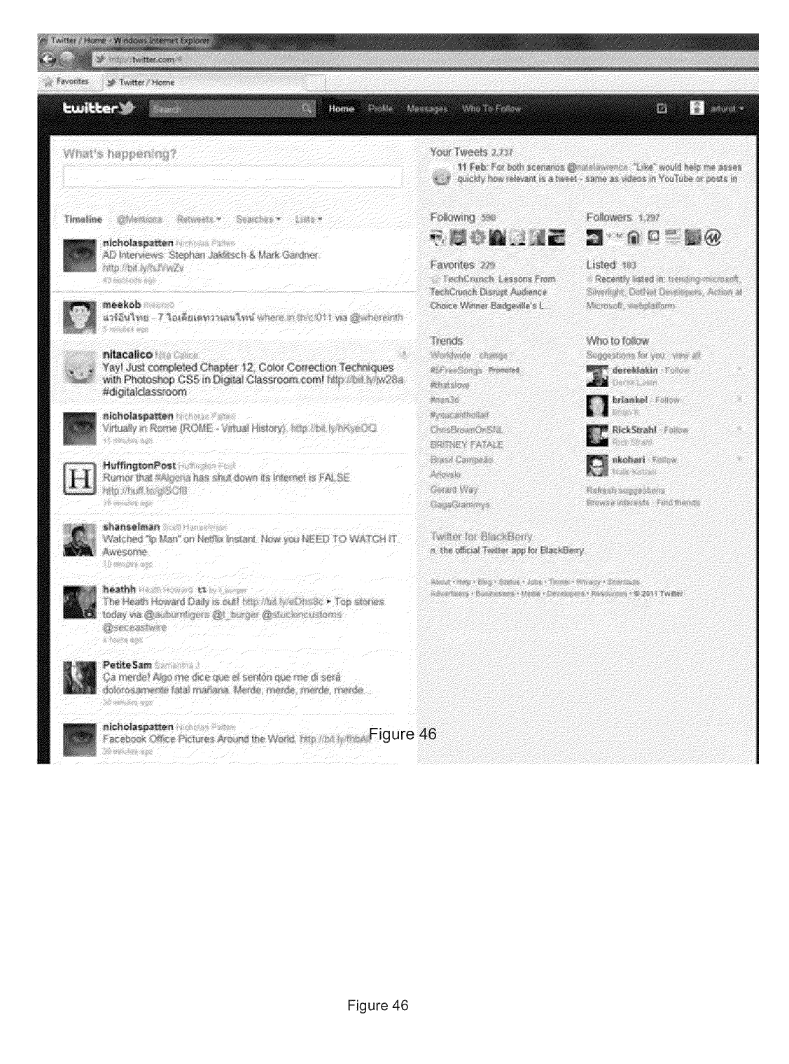

FIG. 46 illustrates that users of the site can share messages to external social networking sites and have those messages shared with their connections on these other sites such as Twitter followers.

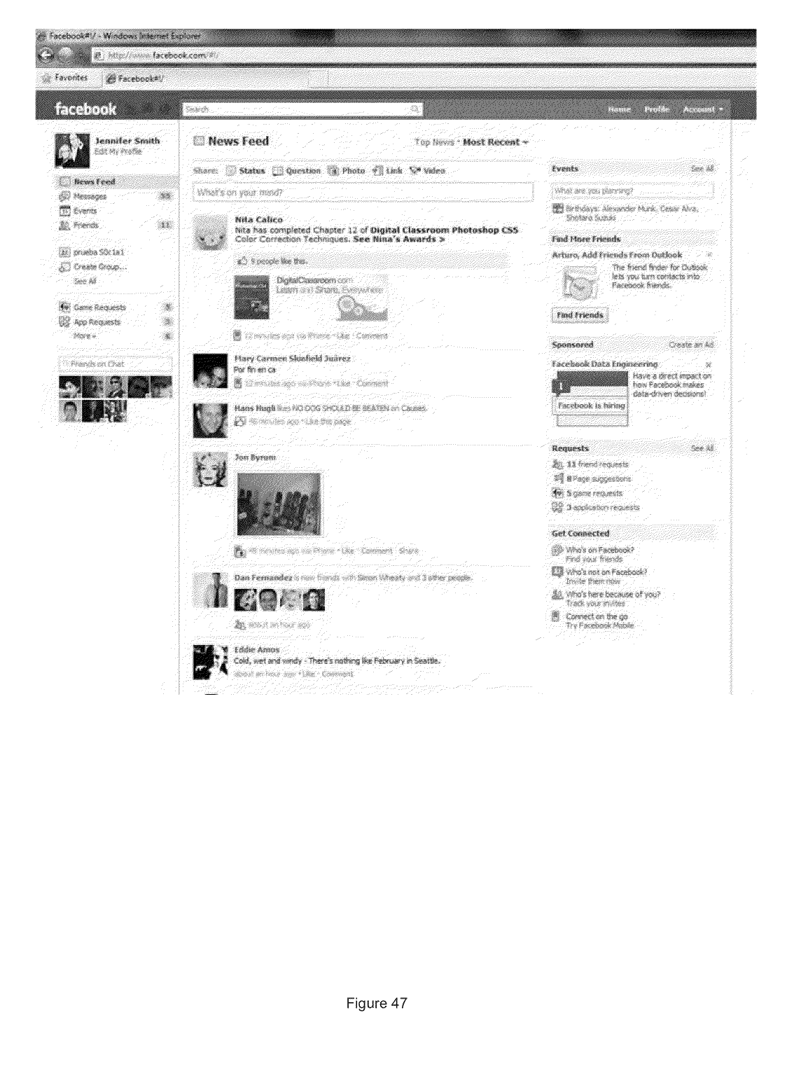

FIG. 47 illustrates that users of the site can share messages to external social networking sites and have those messages shared with their connections on these other sites such as Facebook friends.

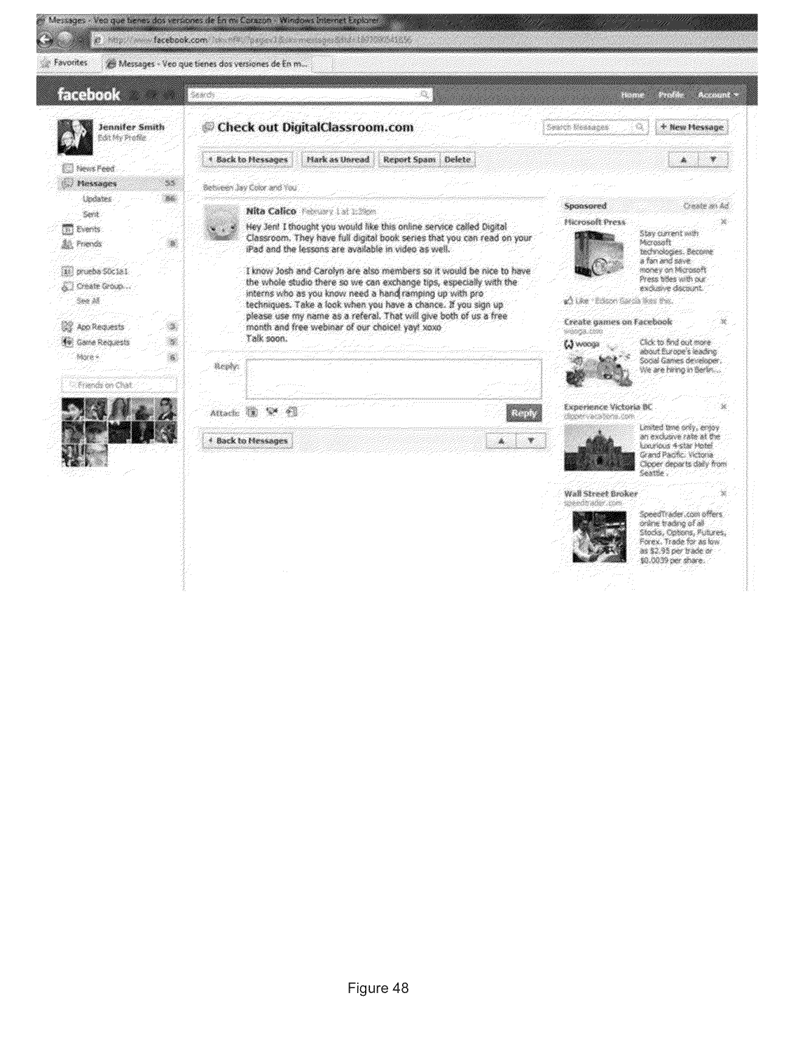

FIG. 48 illustrates that users of the site can share messages to external social networking sites and have those messages shared with their connections on these other sites such as Facebook friends.

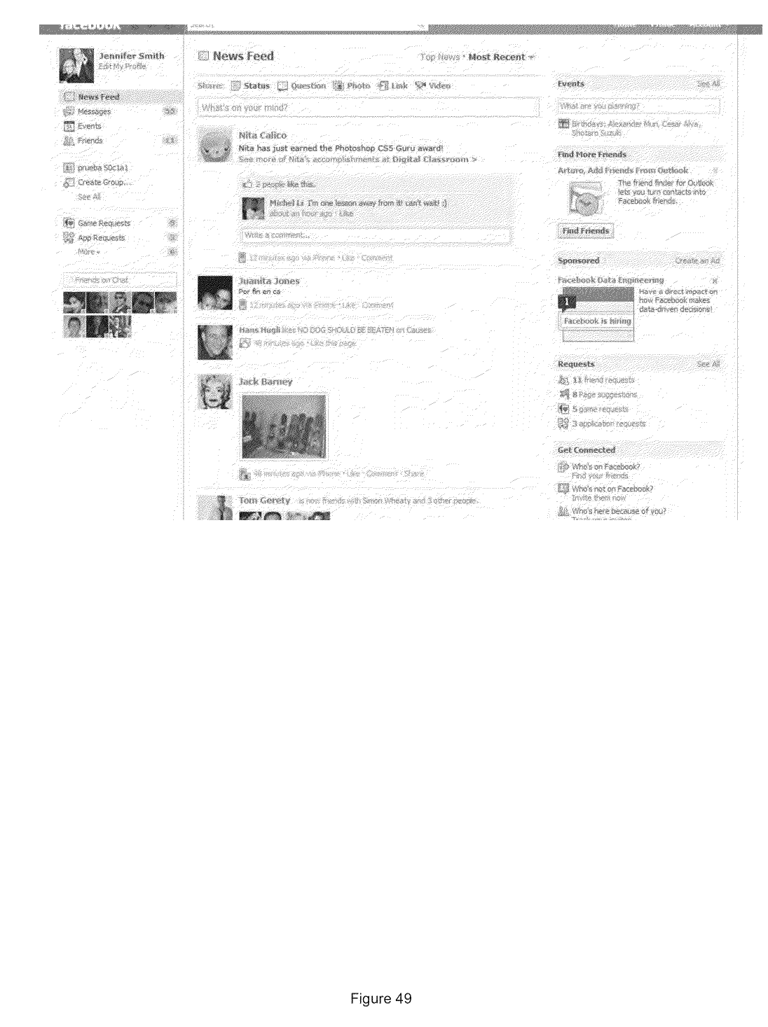

FIG. 49 illustrates that users of the site can share their accomplishments on the site externally to their connections on social networking sites such as Facebook friends.

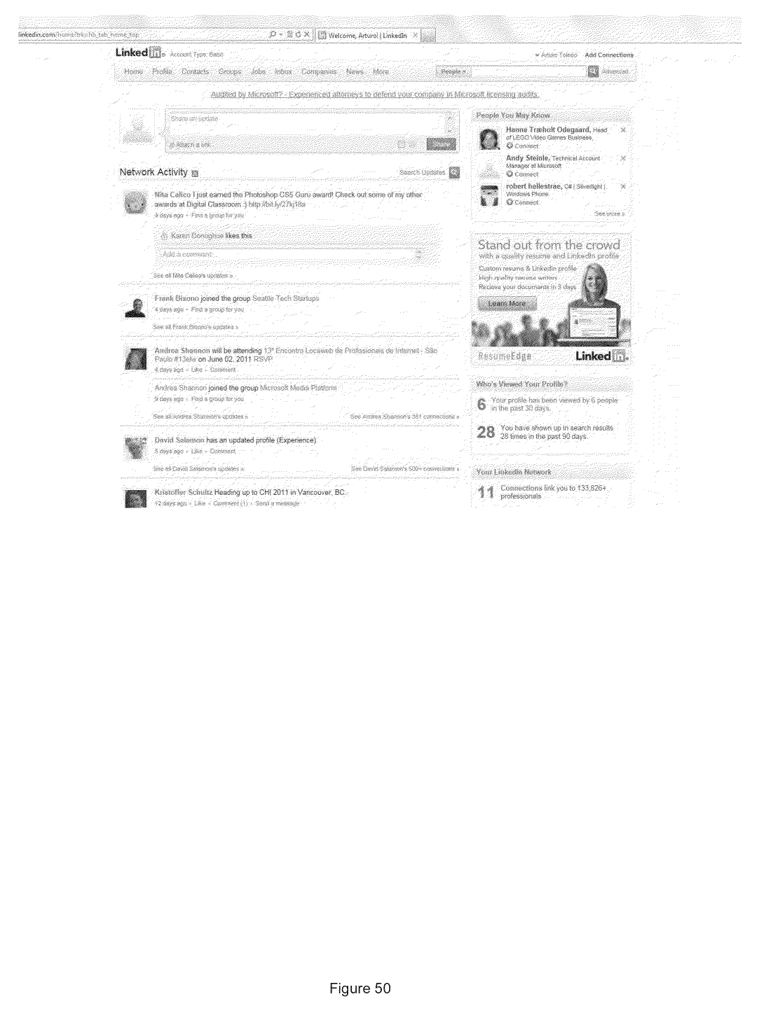

FIG. 50 illustrates that users of the site can share their accomplishments on the site externally to their connections on social networking sites such as such as LinkedIn connections.

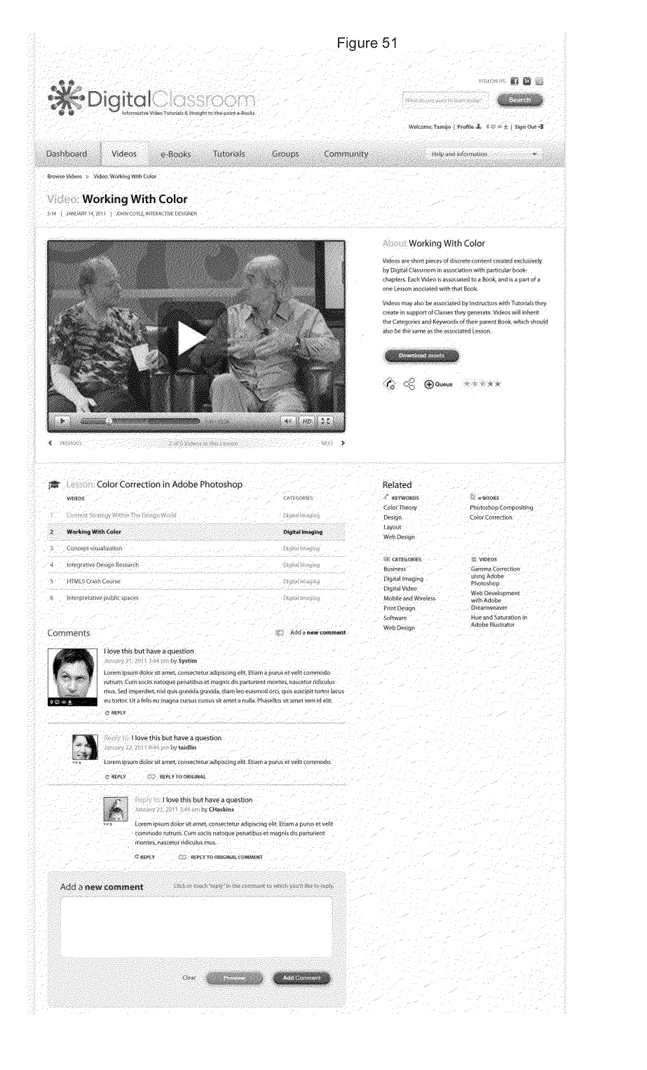

FIG. 51 illustrates that the site contains lesson files that accompany books and videos, and registered users can download the related lesson files from the page containing a video or eBook chaper.

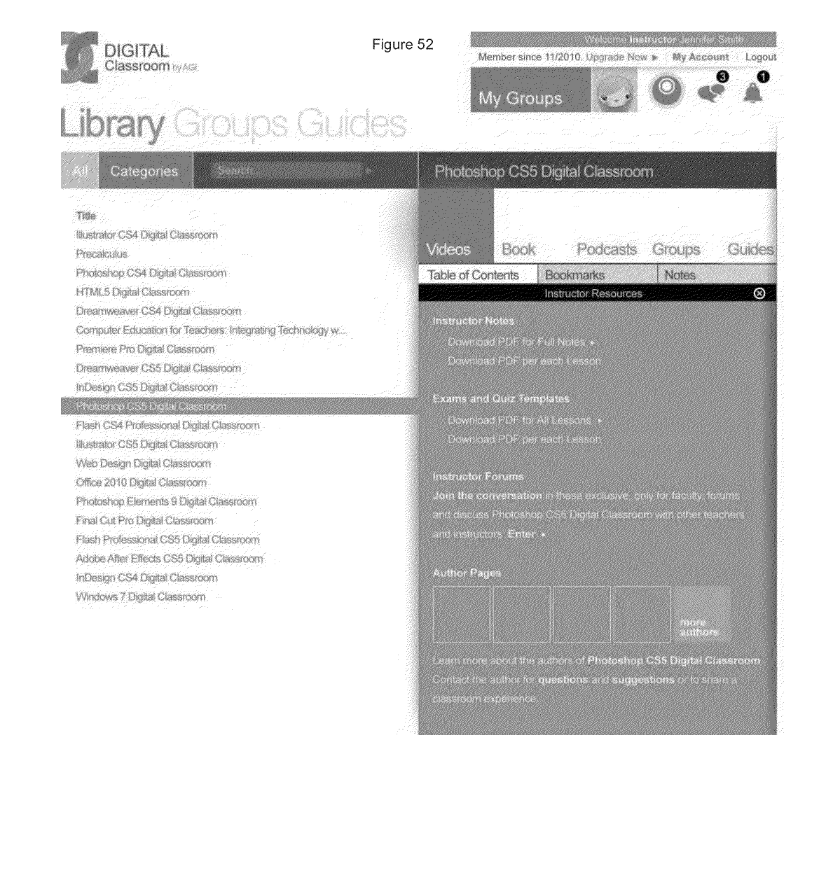

FIG. 52 illustrates that after logging-in instructors using the site have access to extra materials to help them teach. These additional materials can include notes, a private forum for sharing ideas and questions with other instructors or authors, and a repository of test questions and teaching ideas.

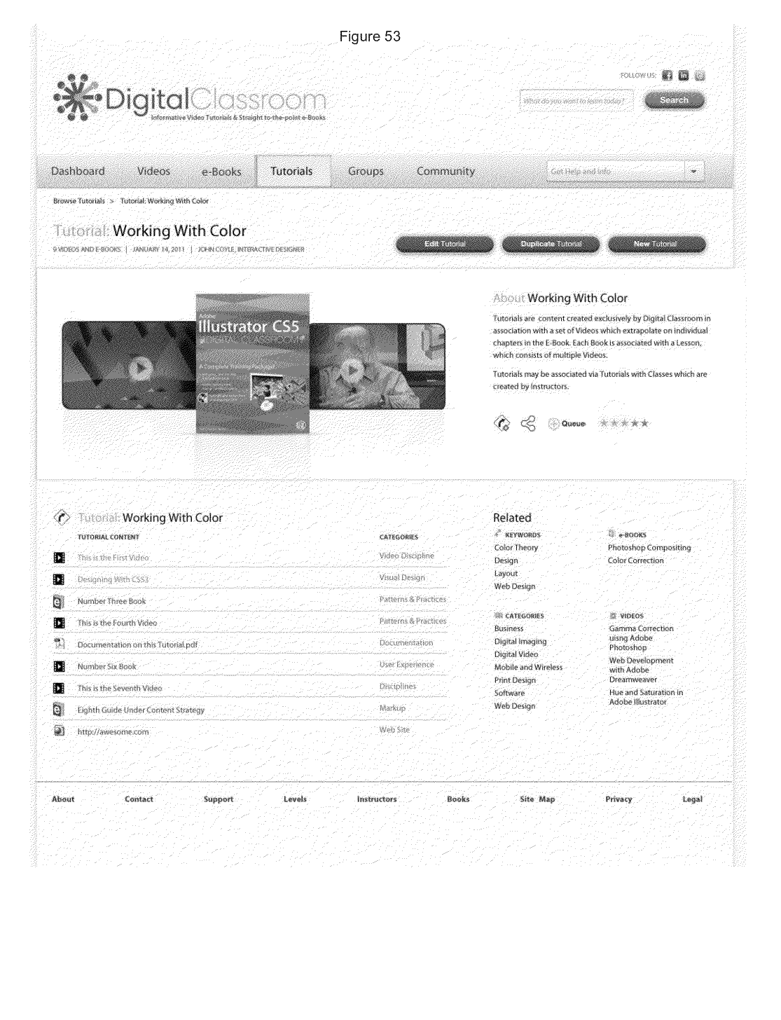

FIG. 53 illustrates how registered instructor users after logging into the site can create new tutorials for student users they are teaching. The tutorials can combine videos, ebooks, and content supplied and upload to the site by the instructor user.

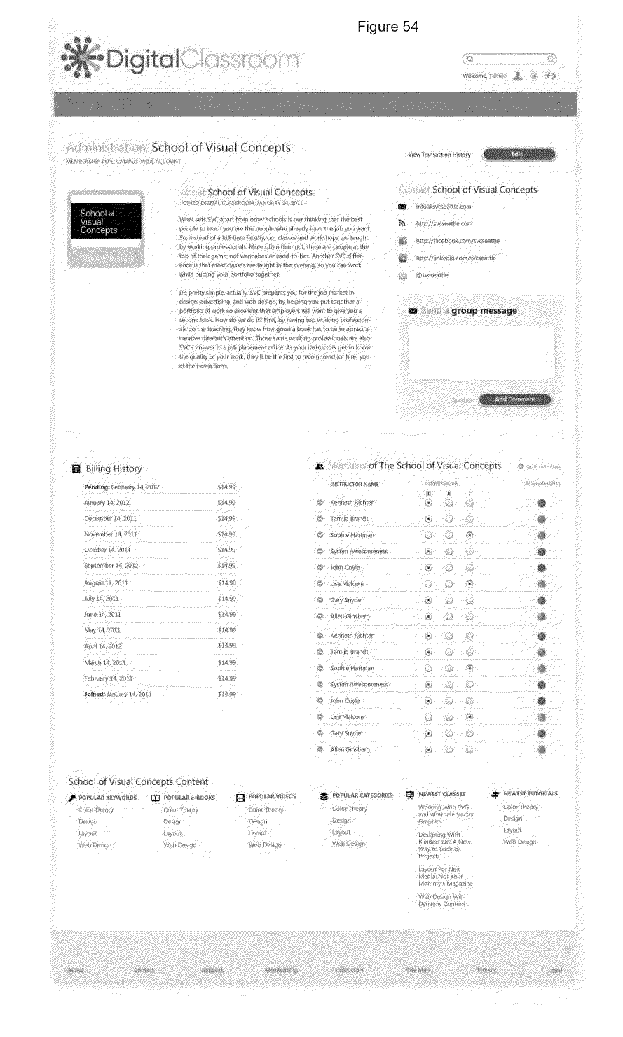

FIG. 54 illustrates that organization-level accounts in the invention provide controls to school administrators or business administrator users. These administrative users can create individual accounts for instructors and students, set access control privileges, and invite new users to join the organization's group on the site.

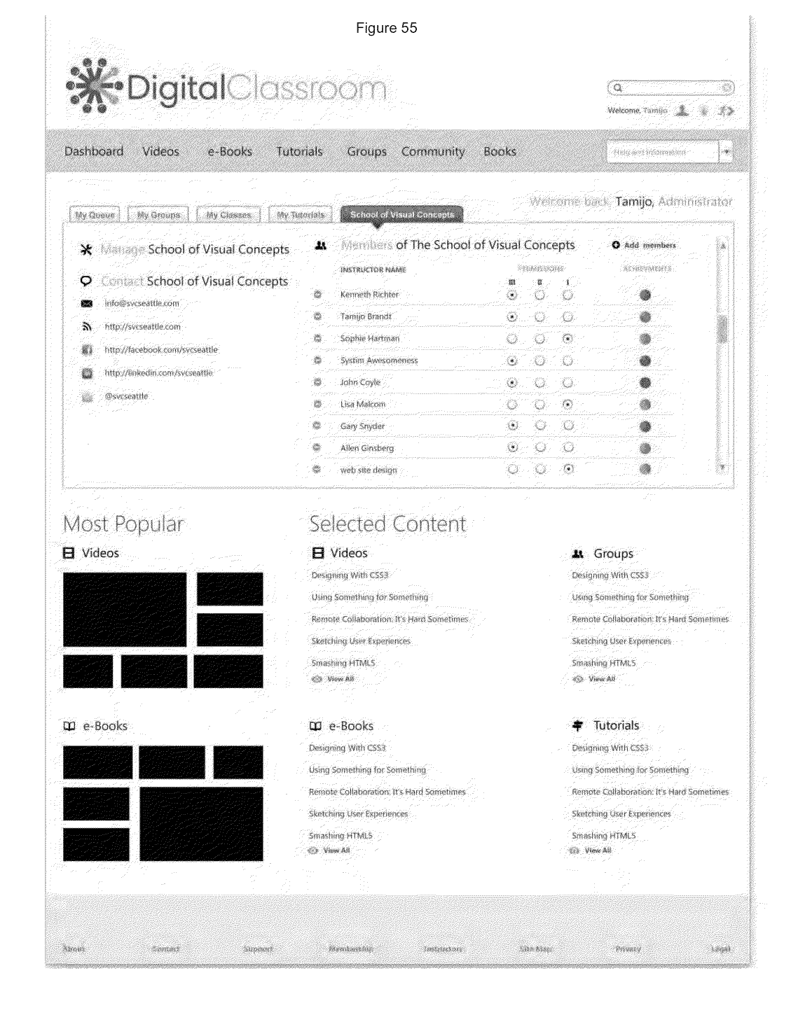

FIG. 55 illustrates how an administrative user of an organization can view a list of all users of the site from the organization, and their role on the site such as whether they are a student user or an instructor user.

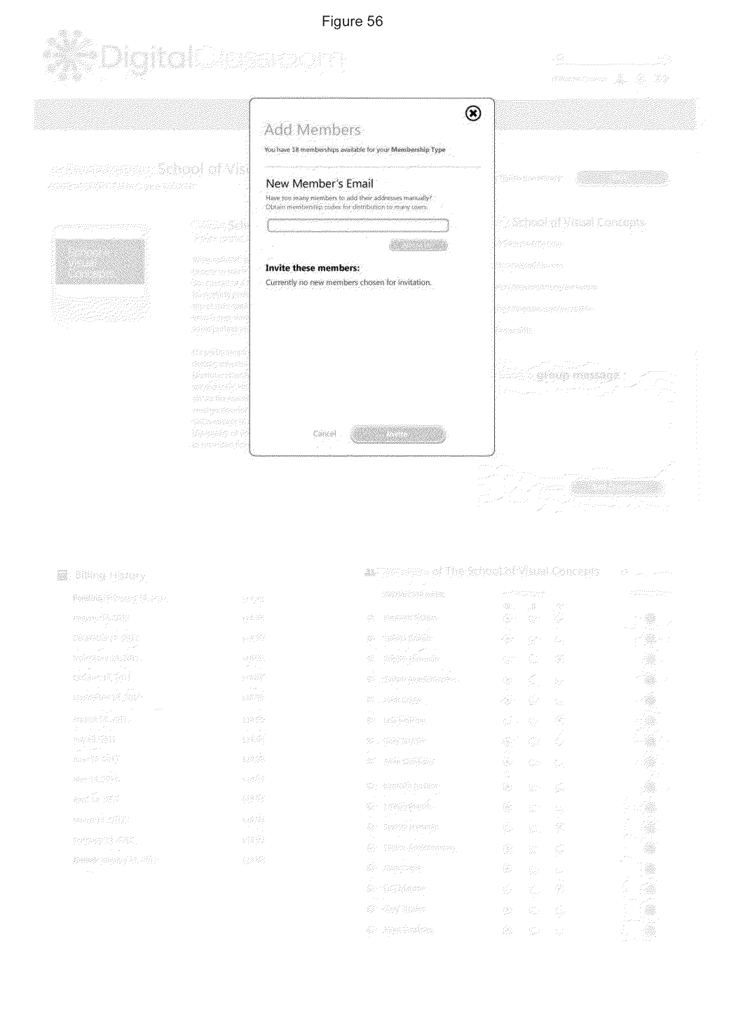

FIG. 56 illustrates how an administrative user can create a new account for an individual to join the site. Administrator users are provided with controls to invite users into the site and to define the roles of these new users, such as defining them to be either a student user or an instructor user.

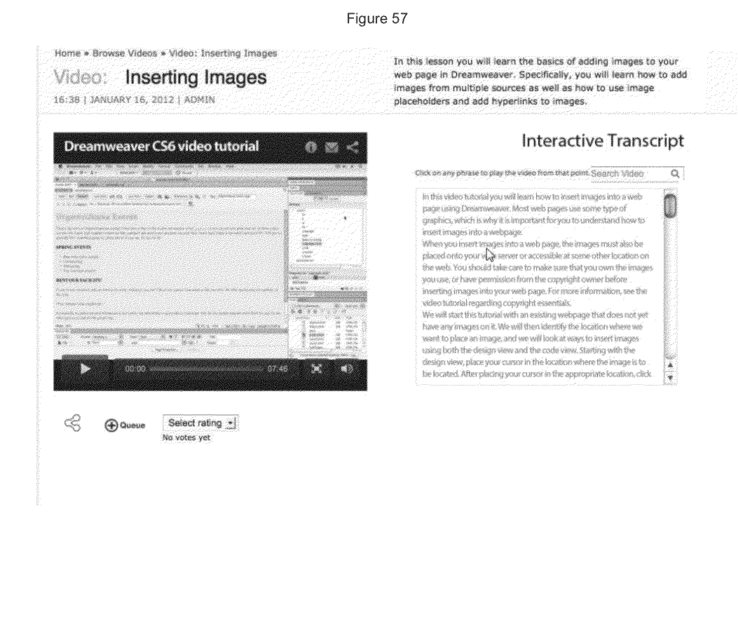

FIG. 57 Illustrates how users reading a transcript of a video can click on the word within the tutorial and be taken to the location in the tutorial where that word is spoken.

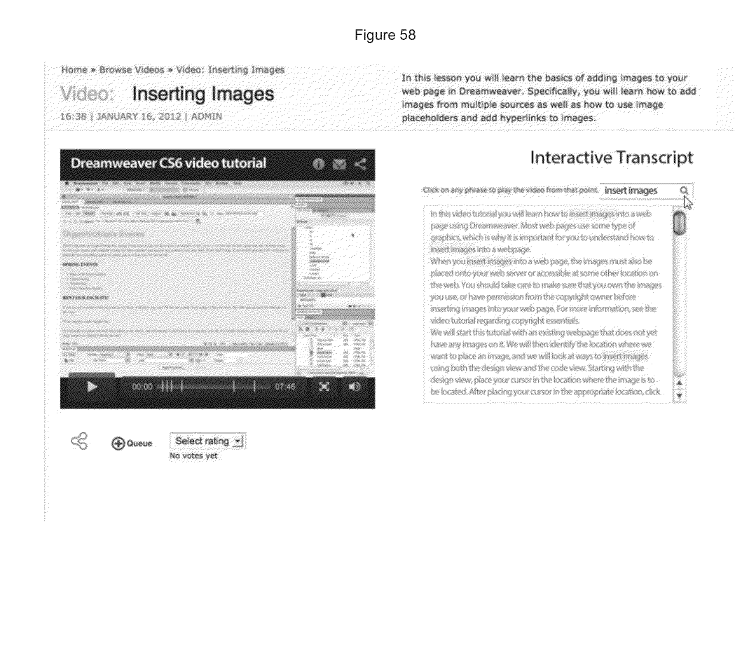

FIG. 58 Illustrates how users of the system can search for content in training videos and videos. Users can search by word or phrase for topics covered in a video being viewed. The search reviews the spoken text in the video. Upon locating the searched word or phrase, the system identifies location in videos where topics are covered by denoting vertical markers in video timeline and also highlights them in the transcript.

When a user submits a search query, the query is run against the closed captioning metadata, and the metadata showing the location of the content is then rendered in the form of vertical markers on the timeline. The user can hover over the vertical markers in the timeline to see the context for the word or phrase that is being searched.

Users of the system can also search video library to locate content within all videos that relates to the search query. The search reviews the spoken text in the video library and displays a list of all videos that include the searched content, with the title of the video and how many times the searched word or phrase is used in the video, and where the phrases occur within the video.

The methods described herein can be encoded in a computer program product, comprising a computer usable medium having a computer readable program code embodied therein. The computer readable program code being adapted to be executed to implement the methods for providing online learning described herein. The computer usable medium can be any as desired, such as compact disks, hard drives, USB readers, flash cards, etc. Preferably, the computer usable medium comprises a non-transitory memory.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, can affect numerous modifications thereto and changes can be made without departing from the scope and spirit of the invention.

1. A method of using an online social learning system to prepare a lesson or tutorial comprising:
connecting to a cloud based social learning server over a network by a user device having a display;
displaying on the user device education material comprising videos, electronic books, or text;
selecting desired educational content from the education material;
optionally uploading user supplied desired content to the social learning server; and
sequencing the selected content to prepare at least one lesson or tutorial, wherein a student user can view the content in the sequence.

2. The method according to claim 1, wherein the lesson or tutorial comprises portions from at least two different books.

3. The method according to claim 1, further comprising storing user information in a membership database, the user information comprising at least one selected from the group consisting of name, username, password, address, email address, and social networking sites to which the user belongs.

4. The method according to claim 1, further comprising streaming live or previously recorded video of the lesson or tutorial from the social learning server to a classroom.

5. The method according to claim 1, further comprising sending a message from the user device to another user device.

6. The method according to claim 1, further comprising monitoring the pages viewed on a student user device and storing the pages viewed and date viewed in a membership database.

7. The method according to claim 4, further comprising using the stored pages viewed and date viewed information to determine when a student started a lesson or tutorial and/or finished a lesson or tutorial.

8. The method according to claim 1, further comprising providing a reward when a milestone is reached by the student user, the milestone comprising a number of pages to be viewed by the student user.

9. The method according to claim 8, further comprising sending a reward to a social network site of the student user when the milestone is reached.

10. The method according to claim 1, further comprising allowing the user to set up a learning queue and bookmark content the user desires to consume at a future point.

11. The method according to claim 1, further comprising allowing viewing of eBooks and video content together as part of a comprehensive service for learning.

12. The method according to claim 1, further comprising allowing users to comment and rate videos and share videos them with other users and non-users of the system.

13. The method according to claim 1, further comprising allowing users to set up groups of users or social learning communities of users on the system.

14. The method according to claim 13, further comprising allowing users to set up a group of student users enrolled in a specific class.

15. The method according to claim 13, further comprising allowing users to set up a social learning community including a local professional association interested in a desired topic.

16. The method according to claim 1, further comprising allowing searching content within videos and eBooks across libraries of videos and eBooks simultaneously.

17. The method according to claim 16, further comprising allowing searching within an individual video or eBook and displaying both the location in the timeline where the searched topics are discussed and in an eBook and where the searched terms appear, wherein clicking on the location displays the video or eBook.

18. The method according to claim 1, further comprising allowing searching a range of videos and eBooks, and displaying a list of videos and eBooks containing relevant content and a location in a timeline where the content appears.

19. A method of using an online social learning system comprising:
connecting to a cloud based social learning server over a network by a user device having a display;
displaying on the user device educational content comprising video content, electronic books or text;
selecting desired educational content;
tacking pages of educational content viewed by the user; and
providing a reward when a milestone is reached by the user, the milestone comprising a number of pages to be viewed by the user.

20. The method according to claim 9, wherein the reward comprises sending a statement to an online social network.

21. The method according to claim 10, wherein the social network comprises at least one of Facebook, Twitter or LinkedIn.

22. The method according to claim 9, further comprising sharing information between a plurality of user devices.

23. An online social learning system comprising:
a cloud based social learning server configured to communicate with a plurality of user devices over a network, the cloud based social learning server comprising a non-transitory memory storing information, the social learning server constructed to monitor pages of educational content opened by a user device and when the pages were opened by the user device;
a membership database located in the non-transitory memory of the social learning server or on a cloud based membership server connected to the network, the membership database constructed to store personal user data including a password and username, and allow grouping of users;
an ePub library located in the non-transitory memory of the social learning server or on a cloud based membership server connected to the network, the ePub library comprising educational books;
a video library located in the non-transitory memory of the social learning server or on a cloud based membership server connected to the network, the video library comprising educational videos;
an instructor's library located in the non-transitory memory of the social learning server or on a cloud based membership server connected to the network, the instructor's library comprising a plurality of tutorials that each comprises content sequenced by an instructor user and wherein at least some of the tutorials include video content, electronic books, or text that the instructor can use to prepare a lesson, and optionally content uploaded by the instructor user;
a first interface for posting milestone and other information of a user to user's social network page when a milestone has been reached, the milestone comprising a number of pages opened on the user device;
a message module configured to facilitate communications between users;
a second message module configured to allow users to receive, store and transmit comments on specific locations within videos and tutorials to thereby share comments with other users; and
a video streaming module configured to stream live or pre-recorded video to a user.

24. The system according to claim 23, wherein the membership database is configure to allow users to be grouped based upon logical communities or professional associations to which they belong.

25. The system according to claim 23, wherein the instructor database is constructed to provide instructor resources including teaching notes, tutorials for using books, videos, and lessons in class, and exam questions provided by curriculum authors and book authors.

26. The invention of claim 1 formed of a computer program product, comprising a computer usable medium having a computer readable program code embodied therein, wherein the computer readable program code being adapted to be executed to implement the method for providing online learning according to claim 1.
